(19) United States
(12) Patent Application Publication
(10) Pub. No.: US 2026/0134321 A1
(43) Pub. Date: May 14, 2026

(54) DESIGNING QUANTUM CIRCUITS WITH TOPOLOGICAL ERROR CORRECTION

(71) Applicant: Classiq Technologies LTD., Tel Aviv (IL)

(72) Inventors: Amir Naveh, Haifa (IL); Shmuel Ur, Shorashim (IL); Avi Elazari, Hod-Hasharon (IL); Gilad Kishony, Haifa (IL); Lior Gazit, Tel-Aviv (IL); Yehuda Naveh, Tel-Aviv Yafo (IL)

(21) Appl. No.: 18/932,175

(22) Filed: Oct. 30, 2024

(51) Int. Cl. G06N 10/40; G06N 10/80

(52) U.S. Cl. CPC G06N 10/40; G06N 10/80

(57) ABSTRACT

A method, product and apparatus including obtaining a logical representation of a quantum circuit having logical qubits and determining a physical representation of the quantum circuit by allocating physical qubits of a quantum computer to quantum components of the physical representation. Such allocating includes determining a pattern of qubit patches representing the logical qubits. A qubit patch includes two slots for representing two logical qubits. The pattern includes an arrangement of the qubit patches in a first number of rows and a second number of columns. The method then includes determining a mapping of the logical qubits to the qubit patches based on first and second factors, determining, based on the mapping, a number of T-factories to be included in each T-factory patch, and synthesizing the quantum circuit according to the physical representation.

### TECHNICAL FIELD

The present disclosure relates to quantum computing in general, and to generation of quantum circuits with topological error correction, in particular.

### BACKGROUND

Quantum computing is a computational paradigm that is fundamentally different from classic computing. In contrast to classic computing, which utilizes bits, quantum computing utilizes qubits. The qubits have unique features, as each qubit can be in superposition, several qubits can be entangled, and all operations on qubits besides measurement (referred to as quantum gates) must be reversible.

Quantum Error Correction (QEC) may be configured to protect quantum information from errors due to decoherence and other quantum noise. Quantum error correction is essential for reducing noise of stored quantum information.

### BRIEF SUMMARY

One exemplary embodiment of the disclosed subject matter is a method comprising: obtaining a logical representation of a quantum circuit, wherein the logical representation comprises a plurality of logical qubits, wherein the logical representation defines a plurality of logical gate operations on subsets of the plurality of logical qubits; determining a physical representation of the quantum circuit based on the logical representation, said determining comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising: determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches; determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and determining, based on the mapping, a number of T-factories to be included in each T-factory patch of the set of T-factory patches; and synthesizing the quantum circuit according to the physical representation, thereby obtaining a synthesized quantum circuit.

Optionally, said determining the pattern comprises selecting the first and second numbers so that an area occupied by the set of qubit patches and by the one or more auxiliary patches surrounding the set of qubit patches, is minimized.

Optionally, said determining the pattern comprises selecting the first and second numbers such that a shape of the area over the lattice is closest to a square shape.

Optionally, said determining the mapping comprises: scoring pairs of logical qubits based on the first factor; ordering the pairs of logical qubits according to their scores, wherein top scoring pairs of logical qubits have a greater number of the simultaneous T-states requests compared to lower scoring pairs of logical qubits; selecting the top scoring pairs; and allocating, for a pair of logical qubits from the top scoring pairs, first and second slots in first and second different qubit patches, the first slot is selected to comprise an available slot that is most adjacent to a first port of a first T-factory patch, the second slot is selected to comprise an available slot that is most adjacent to a second port of a second T-factory patch, the first and second ports are different.

Optionally, said selecting the top scoring pairs is performed according to a score threshold or according to a defined number of pairs.

Optionally, the method further comprises scoring a set of remaining logical qubits based on the second factor, thereby obtaining second scores, wherein the set of remaining logical qubits comprise logical qubits not elected by said selecting the top scoring pairs; ordering the set of remaining logical qubits according to their second scores, from high scores and downwards; selecting a set of logical qubits pairs from the set of remaining logical qubits, based on said ordering; and allocating, for a pair of logical qubits from the set of logical qubits pairs, third and fourth slots of qubit patches, the third and fourth slots are selected to comprise a pair of available slots that are most adjacent to each other compared to other available slots.

Optionally, an adjacency between two elements is calculated based on a number of physical qubits of the lattice that are comprised in a shortest path between the two elements, the shortest path is part of the one or more auxiliary patches.

Optionally, said determining the number of T-factories to be included in each T-factory patch comprises: calculating a number of requests for T-states that are scheduled to reach each port of each T-factory patch as results from said mapping; and selecting, for a T-factory patch, a number of T-factories that is most proportional to the number of requests for T-states that are scheduled to reach a port of the T-factory patch.

Optionally, the method further comprises allocating for the plurality of logical gate operations, respective paths in the one or more auxiliary patches over a set of physical cycles, wherein said allocating the paths is performed according to collision constraints defining that the paths cannot collide within a same physical cycle.

Optionally, an auxiliary path that is allocated for a gate operation between first and second logical qubits comprises a path that physically connects first and second qubit patches from the set of qubit patches, the first and second qubit patches representing the first and second logical qubits according to said mapping.

Optionally, the method further comprises scoring first and second logical qubits based on a number of collisions between their paths; and based on said scoring, adjusting an allocation of slots for the first and second logical qubits.

Optionally, the physical representation utilizes a surface code technique for representing the plurality of logical qubits by the set of qubit patches and for representing the plurality of logical gate operations by the one or more auxiliary patches, whereby errors of the plurality of logical qubits are iteratively corrected every error correction cycle of the surface code technique.

Optionally, the logical representation of the quantum circuit comprises a Directed Acyclic Graph (DAG), wherein nodes of the DAG represent the plurality of logical gate operations, wherein edges between the nodes represent precedence constraints between the plurality of logical gate operations.

Optionally, the lattice comprises a mapping of physical connectivity links between each two physical qubits of the set of physical qubits, wherein the each two physical qubits of the set of physical qubits are either connected or not connected.

Optionally, the method further comprises executing the synthesized quantum circuit on a quantum computer.

Another exemplary embodiment of the disclosed subject matter is an apparatus comprising a processor and coupled memory, said processor being adapted to: obtain a logical representation of a quantum circuit, wherein the logical representation comprises a plurality of logical qubits, wherein the logical representation defines a plurality of logical gate operations on subsets of the plurality of logical qubits; determine a physical representation of the quantum circuit based on the logical representation, said determine comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising: determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches; determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and determining, based on the mapping, a number of T-factories to be included in each T-factory patch of the set of T-factory patches; and synthesize the quantum circuit according to the physical representation, thereby obtaining a synthesized quantum circuit.

Yet another exemplary embodiment of the disclosed subject matter is a computer program product comprising a non-transitory computer-readable medium retaining program instructions, which program instructions, when read by a processor, cause the processor to: obtain a logical representation of a quantum circuit, wherein the logical representation comprises a plurality of logical qubits, wherein the logical representation defines a plurality of logical gate operations on subsets of the plurality of logical qubits; determine a physical representation of the quantum circuit based on the logical representation, said determine comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising: determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches; determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and determining, based on the mapping, a number of T-factories to be included in each T-factory patch of the set of T-factory patches; and synthesize the quantum circuit according to the physical representation, thereby obtaining a synthesized quantum circuit.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary lattice of qubits, in accordance with some exemplary embodiments of the disclosed subject matter;

FIG. 2A shows an exemplary lattice, in accordance with some exemplary embodiments of the disclosed subject matter;

FIG. 2B shows an exemplary qubit route, in accordance with some exemplary embodiments of the disclosed subject matter;

FIG. 2C shows an exemplary qubit route collision, in accordance with some exemplary embodiments of the disclosed subject matter;

FIG. 3 illustrates an exemplary partitioning framework, in accordance with some exemplary embodiments of the disclosed subject matter;

FIG. 4 illustrates an exemplary quantum cycle, in accordance with some exemplary embodiments of the disclosed subject matter;

FIG. 5 illustrates an exemplary scenario, in accordance with some exemplary embodiments of the disclosed subject matter;

FIG. 6 shows an exemplary flowchart diagram of a method, in accordance with some exemplary embodiments of the disclosed subject matter; and

FIG. 7 shows an exemplary block diagram of an apparatus, in accordance with some exemplary embodiments of the disclosed subject matter.

### DETAILED DESCRIPTION

One technical problem dealt with by the disclosed subject matter is to provide an efficient error correction scheme for quantum programs. In some exemplary embodiments, quantum error correction may be necessary for quantum computing, e.g., due to the decoherence property of qubits, which causes qubits to lose their quantum properties quickly in the presence of a constant amount of noise per qubit. In some exemplary embodiments, quantum errors may also result from qubit initialization, measurement errors, qubit loss, qubit leakage, or the like.

In some exemplary embodiments, a qubit's quantum state or property may be described by probability amplitudes. In some cases, errors in the qubit state probability amplitudes may propagate rapidly, if not corrected, causing the qubit state to become unusable. In some exemplary embodiments, one or more quantum error correction codes may be deployed in order to correct quantum state errors. For example, quantum error correction codes may comprise stabilizer codes, topological error correction codes, or the like. In some cases, topological error correction codes may comprise a surface code technique, a color code technique, or the like

In some exemplary embodiments, logical representations of quantum circuits may be designed, programmed or created by a user, a programmer, an operator, or the like, using gate-level programming, using functional-level code, using evolutionary computing techniques such as Quantum Genetic Algorithm (QGA), using genetic algorithms, or the like. In some exemplary embodiments, a logical representation of a quantum circuit may comprise a plurality of logical qubits, and a plurality of quantum operations or gates that are to be applied on the logical qubits according to one or more constraints (e.g., precedence constraints). For example, a logical representation of a quantum circuit may comprise a Directed Acyclic Graph (DAG), in which each node represents one or more quantum operations or gates, and each edge represents precedence constraints between the quantum operations.

In some exemplary embodiments, after an initial logical representation of a quantum circuit is created, it may go through multiple stages before becoming an executable quantum circuit that can be executed on a quantum computer, a quantum cloud, a quantum execution platform, a simulation software thereof, or the like. In some exemplary embodiments, during a compilation stage, a physical representation for the logically-represented circuit may be generated to implement the logical representation. In some exemplary embodiments, while the logical representation may define logical qubits, logical quantum gates, logical cycles, or the like, the physical representation of the quantum circuit may relate to physical qubits of a quantum execution platform, physical gates thereof, or the like. It is noted that a logical qubit, as referred herein, may refer to an individual logical qubit, or to a group of one or more logical qubits (a qubit register), on which quantum operations and manipulations may be performed at a group level.

In some cases, a physical representation of the quantum circuit may be generated to utilize a quantum error correction code such as surface code. In some exemplary embodiments, the quantum error correcting code may be implemented by a quantum execution platform (e.g., a quantum computer) in order to spread information of at least one logical qubit onto a highly entangled state of several physical qubits. In some exemplary embodiments, this may enable to store the information of the logical qubit onto a highly entangled state of the physical qubits. For example, a topological error correction scheme, such as surface code or color code, may achieve quantum error correction by spreading information of one or more logical qubits onto a set of physical qubits. As an example, surface code may comprise an error correction scheme in which logical qubits are represented by respective sets of physical qubits, while enabling operations between the logical qubits, as disclosed, for example, in Fowler et al. “Surface codes: Towards practical large-scale quantum computation” Phys. Rev. A 86, 032324 (18 Sep. 2012), which is hereby incorporated by reference in its entirety for all purposes without giving rise to disavowment. In some exemplary embodiments, syndrome measurements may be used to determine whether a qubit state has been corrupted, enabling the correction of such errors.

In some exemplary embodiments, a logical representation of a quantum circuit may be implementable by different alternative physical representations of the quantum circuit, all of which implementing the same logical representation in a different manner, e.g., using different error correction implementations, using a different number of physical qubits, physical cycles, and/or physical gates, using different types of physical qubits and/or physical gates, or the like. In some exemplary embodiments, utilizing error correction schemes may increase the number of candidate physical implementations that are feasible for the quantum circuit. In some exemplary embodiments, when using an error correction scheme, such as surface code, the logical representation may be implementable by different alternative physical representations of the quantum circuit, all of which implement the same logical representation in a different manner within the surface code framework. For example, surface code may be used to implement the logical representation using various alternative allocations of physical qubits for different functionalities and components of the surface code, thereby enabling to implement the logical representation using a plurality of different alternative surface code implementations.

In some exemplary embodiments, each alternative physical representation of the quantum circuit may comprise a plurality of physical qubits that are manipulated by a plurality of physical gates over a plurality of cycles. In some exemplary embodiments, implementations of a logical representation may differ in their implementation of quantum error correction, which may result with different error rates at the logical level, different execution times, different resource utilizations, or the like. For example, different implementations of quantum error correction may allocate different physical qubits for representing each logical qubit using the surface code. As another example, different implementations of quantum error correction may allocate a different number of physical qubits for each logical qubit. As another example, different implementations of quantum error correction may allocate a different quantity of physical qubits for the entire implementation. As another example, different implementations of quantum error correction may order gate operations differently, implement logical gates differently, or the like. In some exemplary embodiments, implementations of the logical representation must all comply with the same constraints, e.g., precedence constraints between at least a subset of the quantum operations, hardware constraints of the execution platform, constraints derived from an error correction code that is being used, user provided constraints, or the like.

In some exemplary embodiments, it may be desired to find a physical representation of a quantum circuit that implements error correction code such that the execution will result with a low error rate, low execution time, low resource utilization, or the like, e.g., compared to alternative implementations of error correction codes.

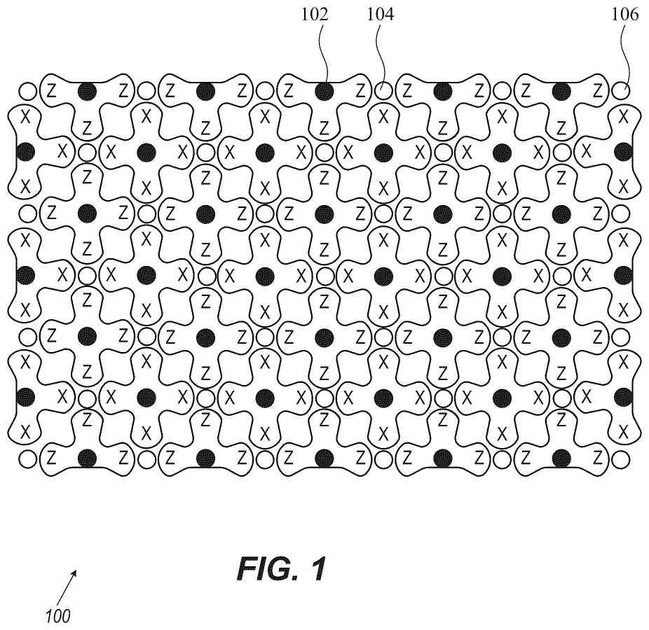

Another technical problem dealt with by the disclosed subject matter is to provide an efficient topological error correction code implementation of quantum programs. In some exemplary embodiments, topological error correction codes, such as surface code, may constitute a class of quantum error correction codes that relies on the topology of a two-dimensional lattice, plane, connectivity graph, grid, or surface (referred to hereinafter as “lattice”, “grid”, or “plane”), which defines the connectivity of the physical qubits. For example, when implementing surface code, the entire lattice, or portions thereof, may be allocated to represent one or more logical qubits and quantum operations may be applied on the represented logical qubits according to a quantum program. In some exemplary embodiments, the topological error correction may be implemented on any lattice of qubits having two or more dimensions. For example, surface code architectures may be employed to periodically correct qubits, e.g., according to the structure depicted in FIG. 1.

Referring now to FIG. 1, depicting an exemplary two-dimensional lattice of a surface code error correction architecture, in accordance with some exemplary embodiments of the disclosed subject matter. As depicted in FIG. 1, a Lattice 100 may comprise a grid of a plurality of physical qubits, each depicted as a white or black dot, e.g., Qubits 102, 104, and 106. In some exemplary embodiments, Lattice 100 may depict physical qubits that represent, as a group, a plurality of logical qubits, a single logical qubit, or the like.

In some exemplary embodiments, Lattice 100 may depict error correction interactions between the physical qubits. For example, black dots such as Qubit 102, may represent ‘measurement’ qubits that are configured to periodically measure and correct attached qubits. In some exemplary embodiments, measurement qubits may measure physical qubits represented as white dots (e.g., Qubits 104 and 106) if they are directly connected or wired thereto. For example, since Qubit 104 is directly connected to measurement Qubit 102, measurement Qubit 102 may periodically measure and correct the state of Qubit 104. As another example, since Qubit 106 is not directly connected to measurement Qubit 102, measurement Qubit 102 may not directly measure or correct the state of Qubit 106, although the state of Qubit 106 may be entangled with the physical qubits that are coupled directly to Qubit 102 (e.g., the state of Qubit 106 may be entangled with the state of Qubit 104). In some exemplary embodiments, by employing the surface code architecture, a quantum state of a logical qubit represented by Lattice 100 or portion thereof may remain stable over time due to the periodic measurements performed by measuring qubits such as Qubit 102.

In some exemplary embodiments, within the lattice setting, interactions between qubits may be limited to their nearest neighbors in the two-dimensional lattice, e.g., Lattice 100, or in a lattice with any other dimensions. For example, Qubit 106 may not interact with Qubits 102 and 104, since they may not be nearest neighbors within Lattice 100 and may not be connected or physically wired to Qubit 106.

In some exemplary embodiments, in some topological error correction schemes, the lattice grid may be partitioned into a plurality of “tiles”, or unit cells. In some exemplary embodiments, in order to form a tile, all physical qubits in a tile may be directly wired (physically connected) to at least one other physical qubit in the tile. In some exemplary embodiments, one or more tiles may be used to host respective “patches” of the lattice, e.g., for representing logical qubits, auxiliary regions for performing operations between logical qubits, or the like. For example, a quantum computer may be partitioned into blocks of tiles, such as qubit patches (also referred to as ‘data blocks’), that host or represent the logical qubits. In some cases, such qubit patches may correspond at least in part to the data blocks disclosed in D. Litinski. “A Game of Surface Codes: Large-Scale Quantum Computing with Lattice Surgery”. arXiv:1808.02892 (2018). arxiv.org/abs/1808.02892, which is hereby incorporated by reference in its entirety for all purposes without giving rise to disavowment (hereinafter referred to as “D. Litinski”). In some exemplary embodiments, all physical qubits in a qubit patch may be directly connected or wired to at least one other physical qubit in the qubit patch. In some exemplary embodiments, the qubit patches may have edges that represent logical Pauli operators.

In some cases, a “qubit patch” that is composed of plurality of physical qubits may represent a single logical qubit. In some cases, a qubit patch may represent more than one logical qubit, e.g., two logical qubits. For example, two or more logical qubits may be represented by a same qubit patch according to an internal distribution of physical qubits to logical qubits within the patch, according to a vertical distribution, according to a horizontal distribution, or according to any other division or distribution. In some cases, one-qubit patches consisting of a single tile may represent one logical qubit, two-qubit patches consisting of two tiles may represent two logical qubits, and so on. In other cases, qubit patches with any other number of tiles may be associated with two or more logical qubits.

In some exemplary embodiments, operations that are defined in the logical representation of the quantum circuit, may be implementable in the physical representation between qubit patches of the lattice. For example, in case the logical representation of the quantum circuit includes a gate operation applied on first and second logical qubits, the gate operation may be applied between a first qubit patch that represents the first logical qubit, and a second qubit patch that represents the second logical qubit, via a path or route formed in an intermediate auxiliary region between the patches (or alternatively, directly between adjacent patches). In some exemplary embodiments, operations that can be applied on qubit patches may comprise qubit initializations, qubit measurements, swaps of quantum states, patch deformations, or the like. For example, patch deformations may comprise adjusting a number of qubits in the patch (e.g., thereby increasing or decreasing its size), adjusting a location of the patch within the lattice, adjusting an identity of physical qubits that form the patch, adjusting an outline (e.g., a shape) of the patch in the lattice and corresponding logical Pauli operators, or the like.

In some cases, an “auxiliary region” may comprise a plurality of physical qubits physically connecting one or more qubit patches, which may be used to apply gates on the qubit patches connected thereby. In some exemplary embodiments, the lattice may comprise one or more auxiliary regions that may be used for applying quantum operations (e.g., gates) between qubit patches of logical qubits. In some cases, an auxiliary region between the qubit patches may be composed of physical qubits that do not represent any logical qubit, and can be used for applying quantum operations between patches. For example, in order to swap quantum states between qubit patches, the states of the qubits may be swapped through the auxiliary region between the qubit patches. In some cases, auxiliary regions may be used to physically implement any other operations that involve at least one qubit patch, e.g., operations between pairs of patches, operations between a T-factory and a qubit patch, or the like. It some cases, logical qubits may comprise auxiliary logical qubits as well as non-auxiliary logical qubits, and the auxiliary region may not represent any type of logical qubit. In other cases, the auxiliary regions may represent auxiliary logical qubits that may be initialized, used to mediate interactions between other logical qubits, and then may be reset to their previous state on demand.

In some exemplary embodiments, qubit patches that represent logical qubits may be referred to herein as qubit patches, while auxiliary regions may be referred to herein as ‘auxiliary patches’. In some exemplary embodiments, patches that represent T-factories may be referred to herein as ‘T-factory patches’. In some cases, T-factory patches may be composed of one T-factory, of multiple T-factories, or the like, and may be configured to generate T-states to be used by the auxiliary patches for implementing logical gates. In some exemplary embodiments, a T-factory may also be referred to as a T-generator.

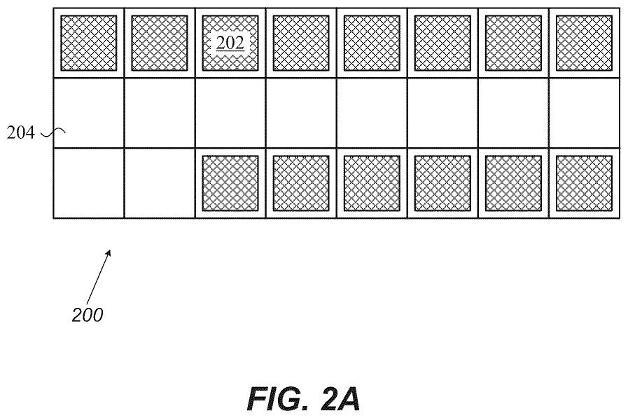

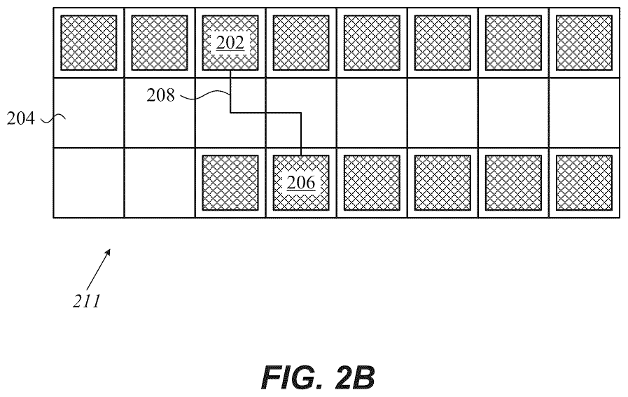

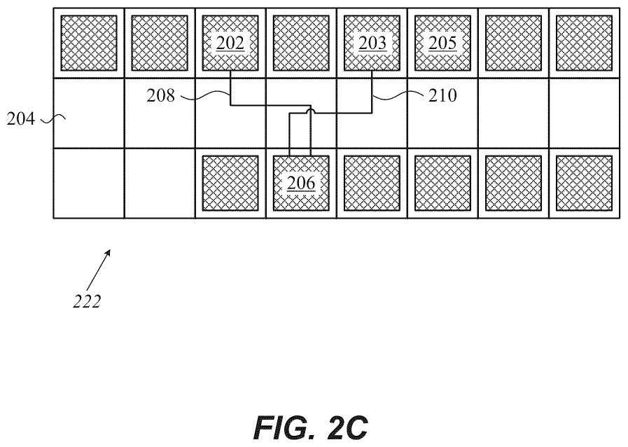

Referring now to FIG. 2A, depicting an exemplary lattice, in accordance with some exemplary embodiments of the disclosed subject matter. As depicted in FIG. 2A, Lattice 200 may be partitioned into qubit patches that represent logical qubits, such as Patch 202. For example, Patch 202 may represent a single logical qubit, a plurality of logical qubits, or the like. In some exemplary embodiments, an auxiliary region such as Auxiliary Patch 204 may surround and connect all the qubit patches of Lattice 200, which may enable to apply operations between qubit patches.

In some exemplary embodiments, when applying a quantum operation between two or more qubit patches via an auxiliary patch that is directly wired or connected to the respective qubit patches, a qubit route or path through which the quantum operation is applied, may be formed within the auxiliary patch. For example, a qubit route between two patches may comprise a continuous route of physical qubits that are all consecutively connected or wired. In some exemplary embodiments, a qubit route may be formed without an auxiliary patch, such as directly between two qubit patches that are adjacent and wired to each other.

In one scenario, a qubit route may comprise physical qubits belonging to the auxiliary patch, that are used to apply an operation such as a quantum gate between patches. In another scenario, a qubit route may comprise physical qubits that are used to swap a quantum state from a first qubit patch to a second qubit patch. In some exemplary embodiments, qubit routes may be required to comprise a continuous line or other shape of physical qubits, a start of which being wired to the first qubit patch and an end of the route being wired to the second qubit patch.

Referring now to FIG. 2B, depicting an exemplary qubit route, in accordance with some exemplary embodiments of the disclosed subject matter. In some cases, Lattice 211 may correspond to Lattice 200 of FIG. 2A. As depicted in FIG. 2B, Lattice 211 may be partitioned into, or allocated to, qubit patches that represent logical qubits, such as Patches 202 and 206. In some exemplary embodiments, a Qubit Route 208 may be formed in an auxiliary region between Patches 202 and 206, in order to apply a quantum operation between logical qubits represented by Patches 202 and 206. In some exemplary embodiments, Qubit Route 208 may comprise a continuous line or other shape of physical qubits that reaches edges of both Patches 202 and 206. For example, Qubit Route 208 may utilize physical qubits of an auxiliary region such as Auxiliary Patch 204.

In some exemplary embodiments, qubit routes may be required not to collide with one another during the same cycle of execution (or set of cycles) of a quantum circuit. In some exemplary embodiments, this requirement may restrict accessible logical operations in each cycle, as they must all comply with the non-collision requirement. In some exemplary embodiments, qubit routes may be considered to collide in case that a physical qubit in the auxiliary patch is used for two or more qubit routes during a single cycle.

Referring now to FIG. 2C, depicting an exemplary qubit route collision, in accordance with some exemplary embodiments of the disclosed subject matter. In some cases, Lattice 222 may correspond to Lattice 211 of FIG. 2B. As depicted in FIG. 2C, Auxiliary Patch 204 of Lattice 222 may comprise a first Qubit Route 208 between Patches 202 and 206, and a second Qubit Route 210 between Patches 203 and 206. As depicted in FIG. 2C, Qubit Route 208 may collide with Qubit Route 210, and thus both routes may not be implemented during the same cycle of a circuit execution. In order to implement quantum operations between Patches 203 and 206 and between Patches 202 and 206, Qubit Routes 208 and 210 may be separated to two different cycles (e.g., while complying with precedence constraints), or, alternatively, Qubit Routes 208 and 210 may be modified to form alternative routes that do not collide.

In some cases, a qubit route may not pass through Auxiliary Patch 204, such as in case of a direct route. For example, a qubit route between the adjacent Patches 203 and 205 may be direct, and may not utilize any physical qubits of Auxiliary Patch 204.

In some exemplary embodiments, in addition to qubit patches and auxiliary patches, a lattice may be partitioned into one or more T-factory patches that represent one or more T-factories, T-state producers, or the like. In other cases, physical qubits of the lattice may be allocated to any other type of patch.

In some exemplary embodiments, universal gates or continuous gates may not necessarily be supported by surface code architectures or other quantum error correction architectures. In some exemplary embodiments, in such cases, in order to apply universal gates in the physical representation, areas of the lattice may be allocated to form one or more T-factories, e.g., within T-factory patches. In some exemplary embodiments, a T-factory may implement one or more predefined logical circuits used to create universal states. In some exemplary embodiments, T-factories may be used to create universal logical states (e.g., magic states or T-states) and provide them to qubits of the auxiliary region, as part of a magic state distillation process. In some exemplary embodiments, generated T-states may be forwarded, e.g., to the qubit patches representing the logical qubits.

In some exemplary embodiments, each T-factory patch may comprise a port, or wired connection, through which generated T-states may be provided, via the auxiliary region, to qubit patches. For example, the port may comprise one or more physical qubits, and may or may not belong to the auxiliary region. In some exemplary embodiments, a T-factory patch may comprise a single T-factory, multiple T-factories, or the like, and a single port. In some exemplary embodiments, logical states created by T-factory patches may be forwarded from the port to edges of requesting qubit patches through one or more qubit routes or paths (e.g., via one or more auxiliary patches). For example, logical T states created by T-factory patches may be applied on adjacent physical qubits from the auxiliary region, and swapped through a qubit route until reaching an edge of a desired qubit patch. According to this example, the T-states may be provided to the desired qubit patch in order to enable a quantum manipulation of the qubit patch.

It is noted that not all the physical qubits of a lattice may be necessarily allocated for implementing a quantum circuit. For example, some physical qubits may remain idle and may not be allocated to any patch, some physical qubits may be allocated to a different quantum circuit, or the like.

In some exemplary embodiments, it may be desired to provide an efficient design or allocation of lattice resources into qubit patches, auxiliary patches, and T-factory patches, while implementing topological error correction code. For example, it may be desired to enhance the performance of an execution of the physical representation that is implemented by the allocated lattice resources, while minimizing the number of allocated resources, cycles, or the like.

Yet another technical problem dealt with by the disclosed subject matter is to design the layout of the physical representation of the quantum circuit, in a manner that minimizes the space-time footprint (e.g., the occupied lattice space and the number of cycles used thereby) and maximized the output fidelity.

Yet another technical problem dealt with by the disclosed subject matter is to design the layout of the physical representation of the quantum circuit by a computational process that does not utilize large volumes of computational resources. For example, it may be desired to provide an algorithm for selecting the layout of the physical representation that is swift and does not require to calculate all the different properties of every possible physical implementation.

In some exemplary embodiments, one or more tradeoffs may exist between execution time of a physical representation, the space it occupies on the lattice, its error rate, or the like. For example, allocating fewer physical qubits for the auxiliary region may reduce the occupied space of the lattice, on the expense of increasing the execution time (e.g., due to the requirement to establish non-colliding paths between qubit patches for each logical operation). For example, the “fast data block” suggested by D. Litinski allows all-to-all connectivity of qubit patches, on the expense of requiring an allocation of a large and wasteful portion of a lattice.

In some exemplary embodiments, any adjustment of the resource allocation may affect the performance of the entire circuit execution. For example, in case two logical qubits are allocated to be represented by two qubit patches that are far from one another (a distance greater than a threshold), and the qubits are manipulated by many common logical gates, the circuit execution may become longer (in terms of cycles) and an error rate of the output quantum state may become higher, compared to a configuration in which the two patches are positioned adjacently to each other, e.g., due to the longer qubit routes, increased collisions between qubit routes, longer duration during which the logical qubits are prone to uncorrectable errors, or the like. As another example, in case each qubit patch is allocated a greater number of physical qubits, an error rate of the patch may be decreased, and vice versa.

In some exemplary embodiments, it may be desired to select an efficient layout of the physical representation, without calculating each and every possible resource allocation to different patches. For example, it may be desired to determine an algorithm that calculates an allocation within a range of optimal results while consuming minimal computational resources (e.g., below a specified threshold).

One technical solution provided by the disclosed subject matter may comprise selecting a layout that implements a quantum circuit using a greedy algorithm, e.g., an allocation scheme.

In some exemplary embodiments, in order to reduce the consumption of computational resources, a layout of a physical representation of the quantum circuit may be selected according to a defined framework, that defines a set of configurations of the physical representation. In some exemplary embodiments, by utilizing the framework, the need to calculate the set of configurations from scratch may be eliminated, thereby conserving computational resources.

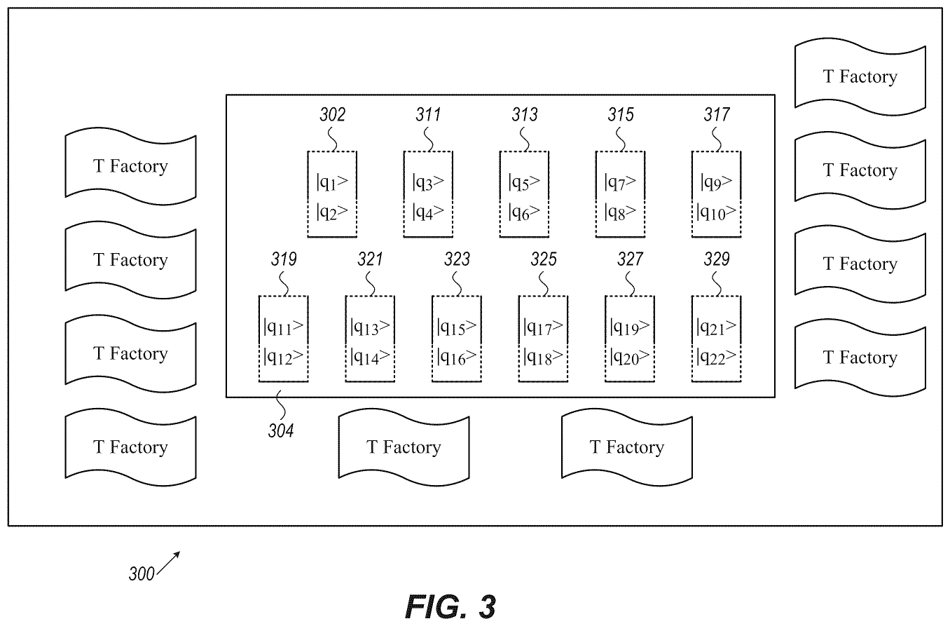

In some exemplary embodiments, a lattice may be designed or partitioned into patches according to one or more frameworks, which may have defined characteristics, configurations, settings, or the like. For example, a partitioning framework such as the framework of FIG. 3 may define a design or layout in which all qubit patches have a uniform size, in which the auxiliary region around the qubit patches has a uniform distribution, or the like. In other cases, any other partitioning framework may be determined.

Referring now to FIG. 3, depicting an exemplary partitioning framework, in accordance with some exemplary embodiments of the disclosed subject matter.

In some exemplary embodiments, Partitioning Framework 300 may define a design or layout for implementing a logical representation of a quantum circuit. In some exemplary embodiments, Partitioning Framework 300 may be used for designing and configuring an allocation of resources of a lattice for a logical representation of a circuit.

For example, Partitioning Framework 300 may be used for designing a layout of qubit patches, auxiliary regions, and T-factory patches.

As depicted in FIG. 3, the qubit patches may comprise two-qubit patches (also referred to as ‘2-qubit patches’) with uniform and consistent shapes and sizes. In some exemplary embodiments, logical qubits of the logical representation may be represented by uniform two-qubit patches with defined sizes, shapes, or the like, e.g., Patches 302, 311, 313, 315, 317, 319, 321, 323, 325, 327, and 329, all of which having a same shape and size. For example, Qubit Patch 302 may comprise a 2-qubit patch that is configured to represent two logical qubits of the logical representation, and has defined size and shape characteristics defined by Partitioning Framework 300. In some exemplary embodiments, qubit patches such as Qubit Patch 302 may represent two logical qubits according to an internal distribution of physical qubits to logical qubits, according to a vertical distribution, according to a horizontal distribution, or according to any other division or distribution. For example, a right side of Qubit Patch 302 may represent a first logical qubit and a left side of Qubit Patch 302 may represent a second logical qubit.

In some exemplary embodiments, the 2-qubit patches may have a uniform qubit-wise size (consistent and identical), irrespective of the scale, and may differ for different implementations. For example, an implementation of a first quantum circuit according to Partitioning Framework 300, may result with each 2-qubit patch being composed of twenty physical qubits, while an implementation of a second quantum circuit according to Partitioning Framework 300, may result with each 2-qubit patch being composed of forty physical qubits.

In some cases, Partitioning Framework 300 may configure a design of an auxiliary region, e.g., Auxiliary Patch 304, between and around the qubit patches, as depicted in FIG. 3. Auxiliary Patch 304 may have a defined layout and design, which, in the scenario of FIG. 3, includes a region (Auxiliary Patch 304) that surrounds all the qubit patches and provides a full connectivity of the qubit patches with one another, through respective paths. For example, the number of qubits in Auxiliary Patch 304 may have a defined ratio compared to the qubit patches, irrespective of the scale. In some cases, Auxiliary Patch 304 may enable application of quantum operations defined by the logical representation between any two qubit patches.

In some cases, Partitioning Framework 300 may configure a design of the T-factory patches, surrounding Auxiliary Patch 304. For example, a certain ratio of physical qubits may be allocated to the T-factory patches, according to the size of Auxiliary Patch 304 and the qubit patches, irrespective of the scale. In some cases, T-factory implementations may correspond to those disclosed in D. Litinski. “Magic State Distillation: Not as Costly as You Think”. arXiv:1905.06903. Quantum 3, 205 (2019), which is hereby incorporated by reference in its entirety for all purposes without giving rise to disavowment.

In some exemplary embodiments, Partitioning Framework 300 may define any other properties of qubit patches, auxiliary patches, T-factories, or the like, such as qubit-wise sizes thereof, shapes thereof, relative positions thereof, or the like. In other cases, any other partitioning framework may be used, with uniform or non-unform distributions of auxiliary regions, properties of qubit patches, or the like, e.g., such as the partitioning framework of FIGS. 2A-2C. For example, a different partitioning framework may or may not provide full connectivity between qubit patches, may utilize one-qubit patches instead of two-qubit patches, or the like.

In some exemplary embodiments, although Partitioning Framework 300 may not necessarily provide a globally optimized implementations for every obtained logical representation, it may provide a consistently efficient and high performing implementation that is statistically optimal. It is noted that the term ‘optimal’ or ‘optimized’, as used herein, may refer to a solution that comprises a global optimum, a local optimum, or neither. In some cases, an optimal solution may refer to a solution that complies with one or more thresholds, that complies with one or more constraints, is within a defined range of sufficiently good results, is within a defined percentile of the results, or the like.

In some cases, Partitioning Framework 300 may optimize on an objective function that is configured to minimize a cost function. The cost function may measure the number of cycles of the physical representation, the number of physical qubits allocated thereto, the number of gates allocated thereto, the error rate, and the number of computational resources that were used to generate the physical representation. In some cases, when taking into account the process of generating the physical representation, using Partitioning Framework 300 may be optimal compared to more customized solutions.

In some exemplary embodiments, although Partitioning Framework 300 defines the basic design of the patches and their layout over the lattice, Partitioning Framework 300 may not define additional required properties of the physical representation of the circuit, such as the number and/or type of each patch, and the mapping between logical qubits to qubit patches. In some cases, the allocation scheme may overcome such challenges and utilize one or more greedy schemes to select and determine the remaining properties.

In some exemplary embodiments, the allocation scheme may be configured to obtain, as input, a logical representation of a quantum circuit (e.g., a DAG representing the circuit), a limit on an error rate (e.g., set by the user), and hardware properties of the quantum execution platform over which the quantum circuit is scheduled to be executed. For example, the hardware properties may comprise a number of available physical qubits on the execution platform, an overall number of physical qubits on the execution platform, quantum operations and/or gates that are applicable by the lattice of the execution platform, T-factories that can be implemented by the platform, or the like. For example, the input may be obtained from a user, from an execution platform, from a compiler or process of the execution platform, a combination thereof, or the like.

In some exemplary embodiments, the logical representation may be processed to determine, based on the logical gates, respective connectivity constraints between logical qubits, wiring requests of quantum elements, precedence constraints between wiring requests, or the like. In some exemplary embodiments, wiring requests, or quantum routing requests, may comprise request to wire quantum elements such as logical qubits and T-factories, such as in order to implement a quantum operation. For example, wiring requests may request a connection between two logical qubits, between a logical qubit and a T-factory in order to obtain a T-state, or the like.

In some exemplary embodiments, two quantum elements may be considered to be ‘wired’ or connected to one another in case a path between the elements exists within an auxiliary region, or directly in case of adjacent elements. For example, the wiring requests may correspond at least in part to those depicted in Table 1.

TABLE 1

| P[0] | Q12 |
|---|---|
| P[1] | Q1 |
| P[3] | Q20 |
| −2 | 13 |
| −2 | 0 |
| −2 | 30 |
| −2 | 11 |

As depicted in Table 1, the wiring requests may comprise connectivity requests, indicating which logical qubit is scheduled to be manipulated together with another logical qubit, which logical qubit is scheduled to obtain T-states, at which cycles, or the [symbol] like. For example, the first row of Table 1 may indicate that [symbol] ubit 12 utilizes a T-state that is obtained from a T-generator denoted as P[0] in Table 1. As another example, the fourth row of Table 1 may indicate that [symbol] ubit 13 is scheduled to be measured (e.g., the measuring operation denoted as ‘−2’ in Table or denoted in any other way).

In some exemplary embodiments, based on the wiring requests, constraints such as precedence constraints between logical operations and connectivity constraints between logical qubits may be determined, extracted, or the like. For example, the constraints may define which quantum elements must connect to which other quantum elements and when (e.g., at what cycles).

In some exemplary embodiments, the allocation scheme may be configured to determine, for each obtained logical quantum circuit that is scheduled to be executed, a layout or design of patches on the target lattice, for implementing the logical representation of the quantum circuit. In some exemplary embodiments, the allocation scheme may determine the layout of the patches according to the defined partitioning framework, such as Partitioning Framework 300 of FIG. 3, according to extracted constraints, or the like. In some cases, the utilization of a defined partitioning framework as a starting point may reduce the computational resources of the allocation scheme significantly, compared to dynamically determining from scratch all properties of each patch independently.

In some exemplary embodiments, determining the layout of the patches according to the partitioning framework may comprise determining the number of slots of qubits per qubit patch (e.g., whether the qubit patches encoded using the surface code are 1-qubit patches, 2-qubit patches, or the like), determining the shape of the qubit patches (irrespective of the scale), determining the structure and size of the auxiliary patches (e.g., relative to the qubit patches and irrespective of the scale), determining the relative size of the T-factory patches, or the like. For example, the relative shapes of the qubit and auxiliary patches may correspond to the architecture of “fast data block” with the respective auxiliary region as disclosed by D. Litinski.

In some exemplary embodiments, the partitioning framework may be implemented by a customized physical representation tailored to each obtained logical circuit. In some exemplary embodiments, the number of the qubit patches encoded using the surface code may be set dynamically to match the number of logical qubits in the obtained logical quantum circuit, such that the number of the slots of the qubit patches is sufficient to house all the logical qubits.

In some exemplary embodiments, after determining the general layout of the physical representation according to the partitioning framework, one or more additional features and properties of the physical representation may be determined by the allocation scheme. In some exemplary embodiments, the additional features may be determined according to one or more greedy algorithms, techniques, or the like.

In some exemplary embodiments, the allocation scheme may determine a pattern or structure of the qubit patches, e.g., as part of the additional features. In some exemplary embodiments, the pattern of the qubit patches may refer to the number of rows and columns of the qubit patches over the lattice. For example, each item constituting the rows and columns may comprise a qubit patch. In some exemplary embodiments, the pattern may be selected before selecting the size of the patches, as they may be scale dependent.

In some exemplary embodiments, the allocation scheme may be configured to select the pattern of the qubit patches based on an area of physical qubits in the lattice (e.g., a relative, adaptable, scale-dependent area) that is required for implementing the qubit patches according to the pattern. For example, the area of the lattice may depend on the auxiliary patches, that are defined by the partitioning framework to surround the qubit patches. In some exemplary embodiments, the allocation scheme may be configured to select a pattern of the qubit patches that minimizes the occupied area of the lattice (e.g., occupied by both qubit and auxiliary patches).

In some exemplary embodiments, in case a set of more than one pattern of qubit patches results with a same overall area, a pattern may be selected from the set in case the pattern is most similar to a square. For example, as the difference between the number of columns and number of rows is smaller, the pattern may be considered “squarer”, and the squarest pattern may be selected and implemented for the physical representation.

As an example, the allocation scheme may analyze the logical representation and determine that the circuit has 537 logical qubits. The allocation scheme may select a pattern for qubit patches hosting the 537 logical qubits. In one scenario, in case of 2-qubit patches, a pattern may be determined for 268 2-qubit patches and a single 1-qubit patch. In another scenario, a pattern may be determined for all 537 logical qubits, under a constraint that requires the number of columns to be even (e.g., to allow to pair the columns of qubits into 2-qubit patches). The pattern that results with a smallest lattice area, and is squarest, may be selected. For example, the factors of 537 may be identified (1×537, 3×179, 7×77, 21×27, and vice versa), and the space for each set of factors may be calculated. In some cases, in case the factors of 537 consume a same area of the lattice, the squarest factors may be 21×27, e.g., since they have a smallest gap between rows and columns, and such factors may be selected.

In some exemplary embodiments, the allocation scheme may determine an overall size of the quantum circuit implementation. In some exemplary embodiments, the total size of the quantum circuit design must account not only for the area required by the qubit patches and auxiliary patches but also for the T-Factories and any necessary empty space. In some exemplary embodiments, the total size may be selected from the available physical qubits on the lattice of the target execution platform.

In some exemplary embodiments, selecting the overall size may involve selecting the size of each patch, in terms of physical qubit numbers. In some exemplary embodiments, the size of the different patches may be determined according to the available resources of the target quantum execution platform, according to error rate limits, and/or any other factor. For example, the scale of the patches may be matched to the available lattice. Referring back to FIG. 3, the size, in terms of physical qubits, of Auxiliary Patch 304 may be determined based on the determined size of each qubit patch, and on the number of available physical qubits on the execution platform.

In some cases, the patch sizes may be selected based on a limit on the error rate (e.g., a threshold obtained from a user), or based on any other factor. In some exemplary embodiments, since the allocation scheme utilizes a defined partitioning framework, the sizes of all qubit patches may be uniform, and calculating a single size of a qubit patch may suffice for calculating all sizes of all qubit patches. This uniformity may result with a reduction in computational resources of the allocation scheme. For example, the size of Qubit Patch 302 (which is identical to the sizes of Qubit Patches 311-329) may be determined based on the error rate threshold, by selecting the minimal scale that complies with the error rate threshold and is available in the target platform. According to this example, after selecting the size of the qubit patches, the size of Auxiliary Patch 304 may be selected according to Equation 1.

For example, the total number of physical qubits allocated to all the qubit patches may be calculated according to the following equation:

$$QPN = L \times P \qquad ( 1 )$$

wherein [symbol] PN denotes the total number of physical qubits allocated to the qubit patches, L denotes the number of logical qubits in the logical circuit, and P denotes the number of physical qubits that compose a single qubit patch (e.g., as determined by the allocation scheme).

In some exemplary embodiments, based on the selected scale of the qubit patches and auxiliary patches, the scale of the T-factory patches may be selected accordingly. For example, the scale of the T-factory patches may be selected to match a defined ratio between the T-factory patches and the qubit and auxiliary patches. According to this example, the ratio may be defined by the partitioning framework, estimated to provide sufficient T-states to the qubit patches, or the like. In some cases, the size or scale of the qubit patches may influence how large each T-Factory patches needs to be, e.g., since T-gate operations may be closely tied to the error correction performed by the surface code. For example, as the qubit patches are larger, the T-factory patches may be required to be larger as well, and vice versa.

In some exemplary embodiments, the total number of physical qubits allocated to the implementation of the quantum circuit may be calculated according to the following equation:

$$Total = QPN + AUX + ( T \times ST ) + E \qquad ( 2 )$$

wherein Total denotes the total number of physical qubits allocated to implement the quantum circuit,

$$Q$$

PN denotes the total number of physical qubits allocated to the qubit patches (as calculated by Equation 1), AUX denotes the total number of physical qubits allocated to the auxiliary patches, T denotes the number of required T-Factories, ST denotes the size of each T-Factory in terms of physical qubits, and E denotes a constant parameter accounting for additional empty space.

In some exemplary embodiments, the parameter ST of Equation 2, denoting the number of required T-Factories, may be calculated based on the computational demands of the quantum circuit. For example, the logical gates of the logical circuit may be analyzed to determine a rate or number of required T-states, and based on the determined number of T-states, the number of required T-Factories may be determined. In some exemplary embodiments, the execution time of the circuit may monotonically decrease as more T-factories are used, along with the respective error rate.

In some exemplary embodiments, the parameter ST of Equation 2, denoting the size of each T-Factory, may be calculated based on the determined uniform size of the qubit patches. For example, the size of each T-Factory may be matches to the scale of the qubit patches.

In some exemplary embodiments, after determining the number and size of the T-factory patches, a type of the T-factories may be selected. In some exemplary embodiments, an execution platform may enable to implement multiple different T-generators, differing in their speed of T-state generation and in the quality of the generated T-states. In some exemplary embodiments, T-generators may differ in their sizes (in terms of physical qubits), error rates created by employing the T-generators, in the yield of T-states (e.g., magic states) created by the T-generators, in their runtime, or the like. For example, a first type of T-generator may be capable of generating a single T-state per 11 cycles, while a second type of T-generator may be capable of generating twelve T-states per 100 cycles.

In some exemplary embodiments, a tradeoff may typically exist between the size and efficiency of T-generators. For example, as a T-generator utilizes more physical qubits (e.g., increased size), its speed of T-state generation and quality of the generated T-states may be increased monotonically, and vice versa.

In some exemplary embodiments, the type of the T-factories may be selected from a list or collection of relevant T-factory types. For example, the relevant T-factory types may comprise types that are supported by the target execution platform, types that are applicable by the target execution platform, types that comply with an error rate requirement, types that utilize a number of physical qubits that matches the allocated lattice size that was allocated for the T-factories, types that overperform other types of T-generators in all or some selected parameters, types that generate error rate within a defined range, or the like. For example, a list of 4,000 types of T-generators may be selected as relevant T-generators from 40,000 existing T-generators.

In some exemplary embodiments, for each relevant T-factory type, their estimated performance parameters, if used for implementing the physical representation, may be calculated. For example, utilizing a T-factory type for the physical representation may require a certain number of the T-factories of the selected type (e.g., up to the allocated number of physical qubits for the T-factory patches), and may result with different properties. For example, selecting to use different T-factory types may result in differing properties such as different size-per-T state (in terms of physical qubit size), different estimated runtime-per-T-state, a different total number of T-states that are generated by the T-generator per cycle, a different quality of the generated T-states, a different number of T generators, a different error rate, or the like. For example, a performance parameter of a T-generator type may denote the number of T-states it can generate per time unit per lattice unit.

In some exemplary embodiments, the estimated performance parameters may be determined and stored as tabular data in a Comma-Separated Values (CSV) file, in a spreadsheet format, in JavaScript Object Notation (JSON) format, in Extensible Markup Language (XML) format, or in any other structured data or non-structured format. For example, performance parameters may be represented and stored according to the following table:

TABLE 2

| T-generator type | Error | #PQ | Runtime | #T-gen. |
|---|---|---|---|---|
| 15to1n | 0.0725 | 354562 | 9.50E+03 | 25 |
| 15to1 | 0.0719 | 270062 | 1.50E+04 | 25 |
| one_level_15to1.16:6:7 | 0.104 | 118750 | 8.40E+03 | 25 |
| one_level_15to1.16:6:7 | 0.108 | 103278 | 9.90E+03 | 21 |
| one_level_15to1.16:6:7 | 0.101 | 39926 | 7.90E+04 | 3 |
| one_level_15to1.16:6:7 | 0.096 | 43794 | 5.90E+04 | 4 |
| one_level_15to1.16:6:7 | 0.109 | 36058 | 1.20E+05 | 2 |
| one_level_15to1.16:7:7 | 0.103 | 32574 | 2.40E+05 | 1 |

According to this example, “T-generator type” may refer to a type of each T-generator (e.g., the type's name), “Error” may refer to the estimated error generated by the respective T-generator, “#PQ” may refer to the number of physical qubits that are required for utilizing the respective number and/or type of T-generators for implementing the quantum circuit, “Runtime” may refer to the execution time of the respective number and/or type of T-generators, and “#T-gen.” may refer to the number of T-generators of the respective type that is required for implementing the quantum circuit. In other cases, any other parameters of T-generators may be measured, stored, or the like. For example, each row of Table 2 may represent a different selection of a T-generator, that matches the constraints and allocated physical qubits for the T-factory patches.

In some exemplary embodiments, the T-generator types may refer to the specific methods or configurations used to generate T states by the respective generator type. In some exemplary embodiments, T-generator types may be described by parameters involved in the T-generation process. For example, the “15to1” generator type of Table 2 denotes a defined structure of a T-generator that generates a single T state per 11 clock cycles with a probability of 99.9%, resulting with a ratio of 1/11 T states per cycles. As another example, the “116to12” generator type denotes a defined structure of a T-generator that generates twelve T states per 99 clock cycles with a probability of 89%, resulting with a ratio of 1/9.27 T states per cycles. As another example, the “one_level_15to1” generator type denotes a one-level T-generator process, set by three parameters, that directly produces T states using the 15-to-1 configuration. For example, the “one_level_15to1” may have three degrees of freedom due to the three parameters. As another example, the “two_level_15to1” generator type denotes a two-level T-generator process, set by seven parameters, that directly produces T states using the 15-to-1 configuration. For example, the two-level T-generator process may involve the distillation of T states through two stages of operations, each refining the quality of the states. As another example, the “two_level_20to4” generator type denotes a two-level T-generator process, set by seven parameters, that directly produces T states using a 20-to-4 configuration.

In some exemplary embodiments, the numbers following the T-generator type, such as 8:3:4:16:8:9:10, represent parameters like distances (dx, dz, dm), the size of the code in different dimensions, the pphys parameter, and other variables that control the error correction and state distillation process. For example, the pphys parameter may represent representing the baseline error rate of the T state before any correction or distillation is applied.

As another example, performance parameters may be represented and stored according to the following table:

TABLE 3

| T-generator type | Error | POUT | Runtime | #PQ | Cost |
|---|---|---|---|---|---|
| two_level_15to1.8:3:4:16:8:9:10 | 0.046 | 5.69e−08 | 67.89 | 19984.0 | 1356790 |
| two_level_15to1.8:2:4:16:8:9:5 | 0.074 | 9.16e−08 | 134.97 | 13064.0 | 1763354 |
| two_level_20to4.10:4:4:18:8:11:5 | 0.102 | 1.26e−07 | 110.22 | 25310.0 | 2789682 |
| one_level_15to1.16:7:6 | 0.105 | 1.30e−07 | 36.77 | 4248 | 156232 |
| one_level_15to1.16:7:7 | 0.053 | 6.52e−08 | 42.62 | 4252 | 181230 |

In some exemplary embodiments, Table 3 lists different configurations of T-generators and evaluations of their associated costs and performances. In some exemplary embodiments, the evaluations may use various metrics such as error rate, probability of output error (POUT), runtime (measured in code cycles per T state), the number of physical qubits it required (#PQ), and the overall cost associated with each T-generator type (a customized metric of combined resource usage). In some cases, the POUT parameter, denoting the probability of an output error, may reflect the likelihood that the T-generator will produce an incorrect state. In some cases, the runtime parameter, measured in code cycle units, may refer to the time taken to generate T states per cycle, and may be measured in a metric such as the number of cycles per T-state. In some cases, the number of physical qubits parameter, denoted as #PQ, may reflect the number of physical qubits required for implementing the T-generator. In some cases, the cost parameter may comprise a combined metric (e.g., according to a cost function) that measures the resource expenditure, such as time, qubits, and operations, necessary to implement the T-generator; a higher cost suggests greater resource usage. In some cases, the cost function may be customized by the user, obtained from a third party, or the like.

In some exemplary embodiments, based on the estimated performance of each relevant T-factory type, as measured according to one or more performance parameters, one type of T-factory may be selected. In some exemplary embodiments, the selected type of T-generator may be used for the physical representation implementing the quantum circuit. For example, a T-generator type that utilizes the highest number of physical qubits while still complying with the hardware constraints may be selected. As another example, a T-generator type may be selected based on criteria such as its error rate, runtime, required quantity, or the like.

In some cases, a type of T-generator (corresponding a row of Table 2 or 3) may be selected according to one or more methods, e.g., greedy methods. For example, a greedy selection may be performed, by calculating the value-per-unit for factors such as the error rate, execution time, the number of physical qubits, or the like, and then applying a weight function to generate a single score for each row. For example, the weight function may assign weights to various parameters based on user configurations (e.g., reflecting user preferences), defined weights, obtained weights, default weights, or similar considerations. According to this example, the row with the highest combined score may be selected, thereby selecting the type and quantity of the T-factory patches. For example, the combined score may correspond to the cost parameter of Table 3, or to any other parameter or combination of parameters.

As another example, a greedy selection may be performed, by calculating for each type of T-generator its probability of output error (the POUT parameter), the number of qubits required, and the number of code cycles needed, e.g., as depicted in Table 3. For example, these parameters may represent the quality of the produced T states of each type of T-generator, and the efficiency of each type of T-generator. According to this example, the efficiency may be measured by the speed by which the respective type of T-generator can produce T states, relative to the resources used (time and space). In some exemplary embodiments, the greedy selection may select a type of T-generator that maximizes both quality and efficiency (e.g., according to a weighting scheme or target tradeoff).

In some cases, tables of performance parameters, such as Tables 2 and 3, may assist the allocation scheme with selecting the T-generator type for the physical representation of the quantum circuit. For example, such tables may assist with determining which T-generator type is most efficient, matches best to user needs or objectives, has the best quality, or the like. For example, the quality of each generator may be evaluated based on whether its error rate is below a defined threshold. In other cases, the quality may be defined in any other way, using any other parameters. In other cases, performance parameters may be determined and/or scored in any other way.

In some exemplary embodiments, after selecting the properties of the T-factories, one or more additional properties of the physical representation may be determined, selected, or the like. For example, the additional properties may comprise the mapping between logical qubits to qubit patches.

In some exemplary embodiments, the allocation scheme may be configured to allocate logical qubits to be represented by each qubit patch. In some exemplary embodiments, the logical qubits may be allocated to qubit patches according to a greedy algorithm (e.g., ‘greedy mapping’), which may be configured to analyze the number of requests for T states from all logical qubits, and select slots of qubit patches for logical qubits based thereon.

In some exemplary embodiments, the number of requests for T states of all logical qubits may be determined, estimated, calculated, or the like. In some exemplary embodiments, the number of requests for T states may be processed to determine, for each pair of logical qubits, the number of times that both logical qubits request T states at the same cycle. In some exemplary embodiments, pairs of logical qubits that rank highest in this criterion, e.g., that request T states at the same cycle for the largest number of times, may be allocated respective slots of qubit patches according to one or more rules. For example, a defined number of highest-ranking logical qubit pairs may be chosen for allocation. As another example, all logical qubit pairs that rank above a defined threshold may be chosen for allocation. As another example, logical qubit pairs that rank above a defined threshold may be chosen for allocation, up to a defined number (e.g., no more than five top-ranking pairs).

In some exemplary embodiments, the selected top-ranking logical qubit pairs may be allocated to slots of qubit patches according to one or more greedy rules, heuristics, or the like, of the greedy mapping. In some exemplary embodiments, the algorithm may select slots for each selected pair, in an order that corresponds to the ranking of the pair. For example, the allocation may be performed according to the order of the ranking, e.g., from the top-ranking pair and onwards, or in any other order. In some exemplary embodiments, for each pair, the first logical qubit of the pair may be allocated to an available slot of a qubit patch that is most adjacent to a port of first T-factory, while the second logical qubit of the pair may be allocated to an available slot of a qubit patch that is most adjacent to a port of a different T-factory. In some exemplary embodiments, slots may be considered available if no logical qubit was assigned thereto. In some exemplary embodiments, separating the high-ranking pairs of logical qubits to be as adjacent as possible to different ports, may reduce the bottleneck of the T-factory patches and ensure that the waiting periods of the qubits to obtain T-states are reduced.

As an example, an exemplary logical quantum circuit may be analyzed to determine, for different pairs of logical qubits, the number of times that both logical qubits of the pair request T states at the same cycle. For example, the analysis may result with an ordered list, such as List 1, ordered according to the number of simultaneous requests.

### List 1:

$$port\_pr [ 0 , 1 ] \vert 15178$$

$$port\_pr [ 1 , 2 ] \vert 8015$$

$$port\_pr [ 2 , 3 ] \vert 3627$$

$$port\_pr [ 0 , 2 ] \vert 3515$$

$$port\_pr [ 0 , 3 ] \vert 2560$$

$$port\_pr [ 0 , 4 ] \vert 1050$$

$$port\_pr [ 1 , 5 ] \vert 858$$

According to this example, the first ranked pair in List 1 is the pair of logical qubits (LQs) numbers 0 and 1, which are determined to request a T-state at the same cycle for 15,178 times. For example, the number of T-state requests may be extracted or inferred from the logical circuit. The next ranking pair may be LQs 1 and 2, which request a T-state at the same cycle 8,015 times, and so on.

It is noted that a ‘port’ may refer to a path or connection to a T-factory patch. For example, after a T-factory patch generates a T-state, it may provide the T-state to its destination via the port. In some cases, as logical qubits request a greater number of T states simultaneously (at the same cycle), it may be desired to separate them as much as possible to different ports of T-factories, in order to prevent bottlenecks on the execution and allow simultaneous acquisition of T states.

In some cases, a set of highest-ranking pairs may be selected and placed in slots of qubit patches that are positioned as close as possible to different ports of T-factories. In some cases, the set of highest-ranking pairs may be determined according to a threshold of pair numbers. For example, the six highest-ranking pairs may be included in the set, regardless of the number of simultaneous requests of the seventh pair. As another example, the set of highest-ranking pairs may be selected according to a threshold of request numbers. For example, only pairs that request T-states simultaneously more than a threshold number of times, e.g., 1,000 times, 3,000 times, or the like, may be included in the set. For example, in case of a threshold of 3,000, the first four pairs in List 1 may be selected to be included in the set. In other cases, any other threshold may be used, and the set of highest-ranking pairs may be defined in any other way.

In some exemplary embodiments, slots of qubit patches may be selected for the set of highest-ranking pairs, based on their proximity to ports. In some exemplary embodiments, in case a partitioning framework such as the framework of FIG. 3 is used, each qubit patch may comprise two available slots for two logical qubits, e.g., since they include 2-qubit patches. In some exemplary embodiments, in case a logical qubit was allocated to a slot, and then appears again in the algorithm, no more slots may be allocated to the qubit. In some exemplary embodiments, each logical qubit may be allocated a single slot, and may be ignored if appearing in any subsequent pair of qubits.

In some exemplary embodiments, after selecting slots for the set of top-ranking logical qubit pairs, any remaining logical qubits may be allocated to the remaining slots of qubit patches according to one or more greedy rules, heuristics, or the like, of the greedy mapping. For example, the remaining logical qubits may be allocated according to a second list, measuring the number of requests for quantum operations such as measurements or gate application between two quantum elements such as qubit patches. In some exemplary embodiments, the second list may or may not be generated to exclude logical qubits that were already assigned to slots.

In some exemplary embodiments, the second list may be determined based on a ‘weight’ of pairs of logical qubits. In some exemplary embodiments, the weight of a pair of logical qubits may measure the number of requests for quantum operations that do not require any T-state, that are scheduled to be applied on the pair together. In some exemplary embodiments, the number of requests for quantum operations between two logical qubits may be determined for pairs of all logical qubits, for a subset thereof, or the like. In some exemplary embodiments, for each evaluated pair of logical qubits, the weight of the pair may be determined, and the pairs may be ordered from top-ranking weights and downwards.

In some exemplary embodiments, logical qubit pairs may be assigned to slots by the order of their weights, such that higher ranking pairs are assigned slots before the lower ranking pairs. In some exemplary embodiments, the pairs may be evaluated according to the order of their weights, until all logical qubits are assigned respective slots of qubit patches.

In some exemplary embodiments, for each evaluated pair, evaluated according to the order of the weights, the components of the pair may be evaluated to identify whether the components are yet to be assigned. For example, in case a logical qubit in the evaluated pair was already assigned a slot, the algorithm may continue to the next component, the next pair, or the like, without assigning another slot to the logical qubit. In some exemplary embodiments, the components of the pair may be evaluated to determine which components include logical qubits. For example, in case the evaluated pair includes a port component, indicating a joint operation is scheduled to be applied between the port and a logical qubit, the port component may not be assigned a slot, since slots are only assigned to logical qubits.

In some exemplary embodiments, in case the evaluated pair includes a first logical qubit that was already assigned to a slot, and a second logical qubit that is not yet assigned to any slot, the second logical qubit may be assigned to a slot that is most adjacent to the first logical qubit. In some exemplary embodiments, in case the evaluated pair includes a port and a second logical qubit that is not yet assigned to any slot, the second logical qubit may be assigned to a slot that is most adjacent to the port.

In some exemplary embodiments, in case the evaluated pair includes first and second logical qubits that were both not assigned to any slot, the pair may be assigned to a respective pair of available slots that is most adjacent to each other. For example, assigning the pair with the most adjacent slots of qubit patches, may enhance the efficiency and time consumption of quantum operations applied on the pair.

In some exemplary embodiments, an exemplary second list, starting with the highest-ranking pairs and proceeding downwards, may result the following list:

### List 2

$$Weight [ 576 ] = {[}^{′} 3 \vert {4}^{′} {,}^{′} 2 \vert {3}^{′} {,}^{′} 1 \vert {2}^{′} {,}^{′} 0 \vert {1}^{′} ]$$

$$Weight [ 432 ] = {[}^{′} 2 \vert {4}^{′} {,}^{′} 1 \vert {3}^{′} {,}^{′} 0 \vert {2}^{′} ]$$

$$Weight [ 288 ] = {[}^{′} 1 \vert {4}^{′} {,}^{′} 0 \vert {4}^{′} {,}^{′} 0 \vert {3}^{′} ]$$

$$Weight [ 256 ] = {[}^{′} 4 \vert {7}^{′} ]$$

$$Weight [ 128 ] = {[}^{′} 0 \vert {7}^{′} {,}^{′} 1 \vert {7}^{′} {,}^{′} 2 \vert {7}^{′} {,}^{′} 3 \vert {7}^{′} {,}^{′} 4 \vert {p}^{′} ]$$

$$Weight [ 80 ] = {[}^{′} 0 \vert {6}^{′} {,}^{′} 1 \vert {8}^{′} {,}^{′} 2 \vert {9}^{′} {,}^{′} 10 \vert {3}^{′} ]$$

$$Weight [ 62 ] = {[}^{′} 5 \vert {6}^{′} {,}^{′} 5 \vert {8}^{′} {,}^{′} 5 \vert {9}^{′} {,}^{′} 10 \vert {5}^{′} {,}^{′} 11 \vert {6}^{′} {,}^{′} 11 \vert {8}^{′} {,}^{′} 11 \vert {9}^{′} {,}^{′} 10 \vert {11}^{′} {,}^{′} 12 \vert {6}^{′} {,}^{′} 12 \vert {8}^{′} {,}^{′} 12 \vert {9}^{′} {,}^{′} 10 \vert {12}^{′} {,}^{′} 13 \vert {6}^{′} {,}^{′} 13 \vert {8}^{′} {,}^{′} 13 \vert {9}^{′} {,}^{′} 10 \vert {13}^{′} {,}^{′} 14 \vert {6}^{′} {,}^{′} 14 \vert {8}^{′} {,}^{′} 14 \vert {9}^{′} {,}^{′} 10 \vert {14}^{′} {,}^{′} 15 \vert {6}^{′} {,}^{′} 15 \vert {8}^{′} {,}^{′} 15 \vert {9}^{′} {,}^{′} 10 \vert {15}^{′} {,}^{′} 16 \vert {6}^{′} {,}^{′} 16 \vert {8}^{′} {,}^{′} 16 \vert {9}^{′} {,}^{′} 10 \vert {16}^{′} {,}^{′} 17 \vert {6}^{′} {,}^{′} 17 \vert {8}^{′} {,}^{′} 17 \vert {9}^{′} {,}^{′} 10 \vert {17}^{′} ]$$

$$Weight [ 50 ] = {[}^{′} 0 \vert {5}^{′} {,}^{′} 1 \vert {5}^{′} {,}^{′} 2 \vert {5}^{′} {,}^{′} 3 \vert {5}^{′} {,}^{′} 0 \vert {11}^{′} {,}^{′} 11 \vert {1}^{′} {,}^{′} 11 \vert {2}^{′} {,}^{′} 11 \vert {3}^{′} {,}^{′} 0 \vert {12}^{′} {,}^{′} 12 \vert {1}^{′} {,}^{′} 12 \vert {2}^{′} {,}^{′} 12 \vert {3}^{′} {,}^{′} 0 \vert {13}^{′} {,}^{′} 13 \vert {1}^{′} {,}^{′} 13 \vert {2}^{′} {,}^{′} 13 \vert {3}^{′} {,}^{′} 0 \vert {14}^{′} {,}^{′} 14 \vert {1}^{′} {,}^{′} 14 \vert {2}^{′} {,}^{′} 14 \vert {3}^{′} {,}^{′} 0 \vert {15}^{′} {,}^{′} 15 \vert {1}^{′} {,}^{′} 15 \vert {2}^{′} {,}^{′} 15 \vert {3}^{′} {,}^{′} 0 \vert {16}^{′} {,}^{′} 16 \vert {1}^{′} {,}^{′} 16 \vert {2}^{′} {,}^{′} 16 \vert {3}^{′} {,}^{′} 0 \vert {17}^{′} {,}^{′} 17 \vert {1}^{′} {,}^{′} 17 \vert {2}^{′} {,}^{′} 17 \vert {3}^{′} ]$$

$$Weight [ 48 ] = {[}^{′} 1 \vert {6}^{′} {,}^{′} 2 \vert {6}^{′} {,}^{′} 3 \vert {6}^{′} {,}^{′} 4 \vert {6}^{′} {,}^{′} 4 \vert {5}^{′} {,}^{′} 0 \vert {8}^{′} {,}^{′} 2 \vert {8}^{′} {,}^{′} 3 \vert {8}^{′} {,}^{′} 4 \vert {8}^{′} {,}^{′} 0 \vert {9}^{′} {,}^{′} 1 \vert {9}^{′} {,}^{′} 3 \vert {9}^{′} {,}^{′} 4 \vert {9}^{′} {,}^{′} 0 \vert {10}^{′} {,}^{′} 10 \vert {1}^{′} {,}^{′} 10 \vert {2}^{′} {,}^{′} 10 \vert {4}^{′} {,}^{′} 11 \vert {4}^{′} {,}^{′} 12 \vert {4}^{′} {,}^{′} 13 \vert {4}^{′} {,}^{′} 14 \vert {4}^{′} {,}^{′} 15 \vert {4}^{′} {,}^{′} 16 \vert {4}^{′} {,}^{′} 17 \vert {4}^{′} ]$$

$$Weight [ 33 ] = {[}^{′} 6 \vert {p}^{′} {,}^{′} 8 \vert {p}^{′} {,}^{′} 9 \vert {p}^{′} {,}^{′} 10 \vert {p}^{′} ]$$

As depicted in List 2, the pairs are ordered according to their weight, e.g., from a rank of 576 to the rank of 33. In some exemplary embodiments, the weight of a pair of quantum components denoted the number of times that the pair requests an application of quantum operations thereon. For example, Weight [576] indicates that the pairs of logical qubits: [‘3|4’, ‘2|3’, ‘1|2’, ‘0|1’] request the application of quantum operations in the respective pairs 576 times during the circuit's execution. For example, the pair ‘3|4’, denoting logical qubits 3 and 4, may request an application of 576 gate operations.

In some exemplary embodiments, the greedy mapping may be implemented by iterating over the pairs, from the highest ranked weighted pairs and downwards, and assign slots to logical qubits of the evaluated pairs in case that no slot was yet assigned to them. In some exemplary embodiments, in case multiple pairs belong to a same weight group (have a same weight), such as in the example of List 2, the order in which the pairs are evaluated within the weight group may be arbitrary, random, or the like. For example, within the weight group of Weight [576], the algorithm may iterate over the pairs ‘3|4’, ‘2|3’, ‘1|2’, ‘0|1’ in any arbitrary order.

In some exemplary embodiments, for each pair that is examined, the algorithm may identify whether the pair includes a logical qubit that was not yet allocated a slot in a qubit patch. In some exemplary embodiments, in case such a logical qubit is identified in the pair, a slot for the qubit may be allocated. In some exemplary embodiments, a slot for the qubit may be selected from the available slots, to be as close as possible to the second component of the pair. For example, a proximity between slots of qubit patches may be assessed and measured according to a distance of a path in the auxiliary region between the slots.

As an example, the algorithm may determine that after allocating initial slots according to List 1, logical qubit number 7 was not yet allocated a slot. According to this example, the algorithm may allocate a slot to qubit 7 according to weights of List 2. As depicted in List 2, qubit 7 first appears in the following row of List 2:

$$Weight [ 256 ] = {[}^{′} 4 \vert {7}^{′} ]$$

This row indicates that qubit 7 is paired with qubit 4, and that quantum operations are scheduled to be applied to the pair of logical qubits for a total of 256 times. According to this example, qubit 7 may be allocated a slot that is most adjacent to qubit 4. For example, qubit 7 be positioned as close as possible to the slot of qubit 4, in terms of path distance.

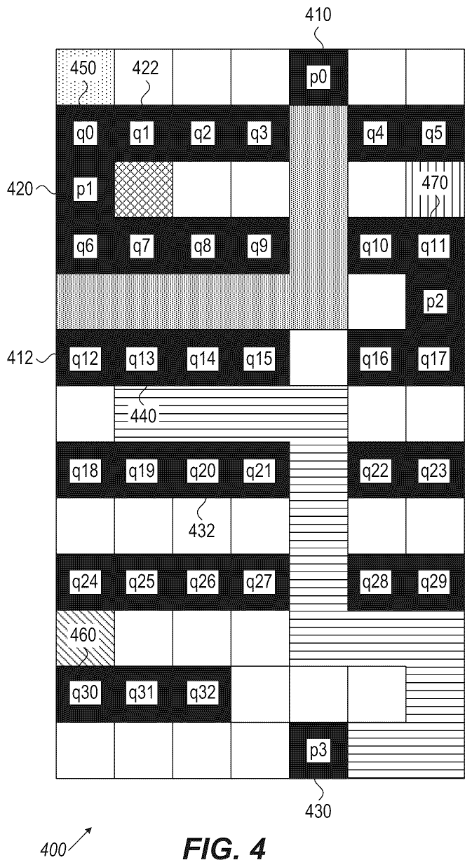

In some exemplary embodiments, allocating slots to logical qubits according to the greedy mapping of Lists 1 and 2, may enable to minimize the intersections between paths of the auxiliary region, reduce the number of cycles required for the circuit execution, and reduce the error rate resulting from idle waiting times. For example, the greedy mapping may enable to apply multiple gate paths at a single cycle, e.g., as depicted in FIG. 4.

Referring now to FIG. 4, depicting an exemplary quantum circuit, in accordance with some exemplary embodiments of the disclosed subject matter.

In some exemplary embodiments, a physical representation of a quantum circuit may be generated to implement, at least in part, a logical circuit. In some exemplary embodiments, the circuit may allocate slots of qubit patches to logical qubits according to the greedy mapping. In some exemplary embodiments, each quantum operation such as gate operations, measurement operations, T-state request, or the like, may be scheduled as a path in an auxiliary region between respective patches.

In some exemplary embodiments, after mapping the logical qubits to respective slots, the allocation scheme may be configured to schedule routes, or paths, for performing quantum operations of the quantum circuit between pairs of qubit patches and between pairs of T-factory patches and qubit patches. For example, the routes may be scheduled according to precedence constraints of the logical circuit, logical operations thereof, or the like. In some exemplary embodiments, cycles may be allocated for each logical operation, such as by ensuring that each cycle excludes path intersections (e.g., preventing application of gates with intersecting paths in a same cycle).

In some exemplary embodiments, an execution of the circuit may enable to apply multiple gate paths (e.g., referring to a path of the auxiliary region implementing a gate) at a single logical cycle. For example, Cycle 400 depicts a logical cycle in which seven different gate paths are applied during the same cycle. As depicted in FIG. 4, a first gate path connects Port 410 with Qubit 412, a second gate path connects Port 420 with Qubit 422, a third gate path connects Port 430 with Qubit 432, a first measurement gate is applied to Qubit 440, a second measurement gate is applied to Qubit 450, a third measurement gate is applied to Qubit 460, and a fourth measurement gate is applied to Qubit 470. In some exemplary embodiments, the greedy mapping may attempt to maximize the number of parallel gate paths and measurements that are performed simultaneously during a single logical cycle, and to minimize thereby the overall number of cycles.

In some cases, the number of path intersections between gate paths of qubit patch pairs over a set of cycles may be analyzed, and qubit patch pairs with a highest number of intersecting gate paths may be identified. For example, a qubit patch pair with a high number of path intersection may comprise a first logical qubit that is manipulated by quantum operations through paths that intersect a high number of times with paths of the second logical qubit (e.g., above a threshold or ratio). In some cases, the mapping of the logical qubits to respective slots may be adjusted, by replacing the slot of at least one of the logical qubits with a slot that enables the paths of the qubits to no longer intersect.

In some exemplary embodiments, the allocation scheme may comprise selecting a number of T-factories for each T-factory patch. In some exemplary embodiments, each T-factory patch may comprise a port and one or more T-factories. In some exemplary embodiments, the number of T-factories may differ for different patches, e.g., in a non-uniform way. For example, one T-factory patch may comprise two T-factories and a second T-factory patch may comprise three T-factories.

In some exemplary embodiments, the number of T-factories for each T-factory patch may be selected to be proportionate to the respective number of T-state requests. For example, after mapping the logical qubits to respective slots, the number of T-state requests that are scheduled to be provided to each port of a T-factory patch may be calculated, and the ratio between the T-factory patches may be determined. Based on the ratio, the number of T-factories for each T-factory patch may be selected to correspond as much as possible to the ratio. For example, if a first T-factory patch obtains 3 times more T-state requests than a second T-factory patch, the first T-factory patch will be allocated 3 times the number of T-factories. In some cases, in case the sizes of the T-factories do not correspond to the determined ratio, or any other constraints prevent full adherence to the ratio, the numbers of T-factories allocated to each patch may be selected to be as close as possible to the determined proportion.

In some exemplary embodiments, one or more search algorithms may be used to analyze a solution space, such as a solution space that incorporates different numbers of T-factories for each T-factory patch, different path intersections between paths of pairs of qubits over a set of cycles, different mappings of logical qubits to respective slots, or the like. In some exemplary embodiments, search algorithms such as genetic search, genetic algorithms, a fitness function, particle swarm optimization functions, simulated annealing, binary search, linear search, or the like, may be applied to the solution space and determine one or more result vectors. For example, a result vector may be used to generate an optimized quantum program that includes an optimized selection of layouts and resource allocations.

In some exemplary embodiments, a physical representation of the quantum circuit may be generated and synthesized according to the determined layout and properties determined by the allocation scheme. In some exemplary embodiments, the physical representation may be executed on a quantum execution platform such as a quantum computer, a quantum cloud, or the like.

One technical effect obtained by the disclosed subject matter is providing an efficient error correction scheme for quantum programs, within the domain of topological error correction codes. The disclosed subject matter determines a lattice scheme with optimized allocations of physical qubits to patches, with reduced computational resources for determining the allocations.

Another technical effect obtained by the disclosed subject matter is mapping logical qubits to slots in qubit patches in an optimal greedy manner that minimizes the lengths of paths for obtaining T-states from T-factories. Since requests for T-states are more frequent and significant than requests for inter-qubit operations, in terms of their effect on the performance of the circuit execution, mapping logical qubits according to requests for T-states may be advantageous.

Yet another technical effect obtained by the disclosed subject matter is improving the execution performance by distributing logical qubits that request T-states simultaneously across different ports. In some cases, this may help to reduce load and alleviate bottlenecks.

Yet another technical effect obtained by the disclosed subject matter is enabling to minimize intersections between paths that implement gate operations.

Yet another technical effect obtained by the disclosed subject matter is enabling to select optimal patterns for qubit patches in the lattice. For example, qubit patches may be arranged in a manner that enhances execution properties such as the number of cycles, error rate, or the like.

Yet another technical effect obtained by the disclosed subject matter is enabling to enhance a quantum error correction scheme using non-uniform allocations of T-factories for T-factory patches. In some exemplary embodiments, instead of dividing the T-factories equally to the T-factory patches, the T-factories may be provided in accordance with the ratio of T-state requests that are handles by each patch (via the respective port). The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

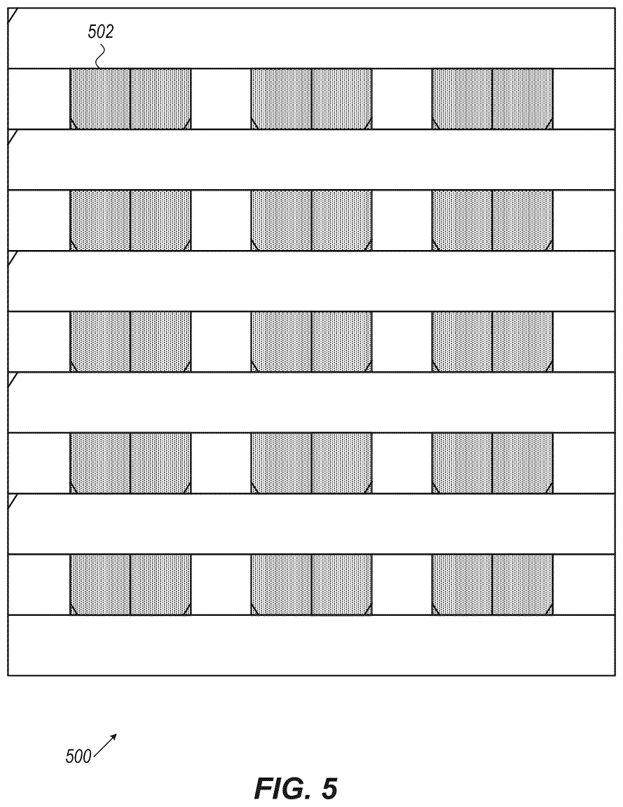

Referring now to FIG. 5, depicting an exemplary scenario, in accordance with some exemplary embodiments of the disclosed subject matter.

In some exemplary embodiments, a quantum circuit such as Circuit 500 may be generated according to a partitioning framework such as Partitioning Framework 300 of FIG. 3. As depicted in Circuit 500, each qubit patch may comprise a 2-qubit patch representing two respective logical qubits. For example, Qubit Patch 502 may correspond to Qubit Patch 302 of FIG. 3.

In some exemplary embodiments, the allocation scheme may be configured to obtain or extract a number of logical qubits from the logical representation, and determine the number of qubit patches accordingly. In some exemplary embodiments, the pattern of the qubit patches, which may be interweaved with the auxiliary region, may be determined to comprise a number of rows and columns of the qubit patches over the lattice. In some exemplary embodiments, the allocation scheme may select the pattern to have a smallest overall area of the qubit patches and auxiliary patches. In some exemplary embodiments, the overall area may comprise the area occupied by the qubit patches, which may remain constant, to which the area occupied by the respective auxiliary region is added. In some exemplary embodiments, in case more than one pattern results with the same overall area, the pattern that is most square may be selected. For example, in the scenario of FIG. 5, the allocation scheme may select for Circuit 500 a pattern of 5×3 qubit patches (five rows and three columns).

In some exemplary embodiments, the auxiliary patches may be set or selected to match the pattern of the qubit patches, such as according to the partitioning framework that is being used. For example, in the scenario of FIG. 5, the allocation scheme may select the auxiliary patches to surround the qubit patches from all sides, thereby enabling an all-to-all configuration. The scale of the auxiliary patches may be set to match the scale of the qubit patches. In some exemplary embodiments, the allocation scheme may be configured to utilize a partitioning framework only in case it provides an all-to-all configuration. In other cases, any other partitioning framework may be utilized.

In some exemplary embodiments, the allocation scheme may be configured to select a greedy mapping of logical qubits into respective slots of the 2-qubit patches. For example, the greedy mapping may be performed according to the above lists, e.g., Lists 1 and 2. For example, the greedy mapping may be performed according to a number of simultaneous T-state requests of qubit pairs, and according to a number of quantum operations that are scheduled to be performed on qubit pairs.

In some exemplary embodiments, the allocation scheme may be described, in some exemplary scenarios, according to the following exemplary pseudo code:
1. Obtain a logical representation of a quantum circuit.
2. Extract the number of logical qubits from the logical representation.
3. Select a pattern (along y and x axes) of the qubit patches and auxiliary patches, by:
   a. initializing the following parameters:

$$area = initialize to a large number such as 9999999$$

$$qubit\_num = initialize to the number of logical qubits from step 2$$

b. implementing the following loop:

$$for a parameter y 2 in range ( 1 , int ( qubit\_num / 4 ) + 1 ) :$$

$$yy = y 2 * 2 // number of rows of 2 - qubit patches$$

$$xx = math . ceil ( self . qubit\_num / yy ) // number of columns$$

$$lx = xx * 2 + int ( ( xx - 1 ) / 2 ) // add auxiliary qubits to columns$$

$$ly = 1 + yy // add auxiliary qubits to rows$$

$$area 1 = lx * ly // total area including auxiliary qubits$$

$$if area >= area 1 :$$

$$area = area 1$$

$$self . layout = [ xx , yy , lx , ly ]$$

wherein:
xx keeps track of the number of logic qubits along the x dimension (e.g., columns)
yy keeps track of the number of logic qubits along the y dimension (e.g., rows)
lx keeps track of the number of logic and auxiliary qubits along the x dimension
ly keeps track of the number of logic and auxiliary qubits along the y dimension
the ‘area’ parameter keeps track of the minimum area that is found.
4. Add T-factory patches and their ports to the layout, according to the partitioning framework (e.g., the partitioning framework of FIG. 3).
5. For each pair of logical qubits, generate a first list of requests for T-states that both logical qubits initiate at the same cycle (e.g., corresponding to List 1).
   a. utilize counters to count, for pairs of qubits, how many times the qubit pair requires T-states in the same cycle.
   b. order the counters from high to low.
6. For each pair of logical qubits, generate a second list of requests for quantum operations that are scheduled to be applied on the pair (e.g., corresponding to List 2).
   a. utilize counters to count, for pairs of qubits, how many times the qubit pair requires to apply quantum operations on the pair.
   b. order the counters from high to low.
7. Allocate logical qubits to qubits patches: Set a first threshold to include a maximal number of pairs or a maximal number of T-state requests. Iterate over the first list. For each pair that complies with the first threshold, perform:
   a. allocate for the two logical qubits of the pair a slot in available qubit patches that are most adjacent to different ports.
8. Set a second threshold to include a maximal number of pairs or a maximal number of operation requests. Iterate over the second list. For each pair that complies with the second threshold, perform:
   a. In case the pair includes two logical qubits that are already allocated to slots, do nothing.
   b. In case a first qubit in the pair is already allocated to a slot and the second qubit is not, allocate the second qubit to an available slot that is most adjacent to the first qubit.
      i. Calculate which slot is most adjacent to the first qubit according to a number of auxiliary qubits separating the slots, which corresponds to the distance in the lattice.
      ii. in case of multiple slots with equal distances, select an available slot randomly from the multiple slots.
   c. In case a first member of the pair is a port and the second qubit is not allocated to a slot, allocate the second qubit to an available slot that is most adjacent to the port (calculate adjacency as in the above step).
   d. In case both qubits in the pair are not allocated to slots, find two available slots that are most adjacent to each other and allocate these slots to the pair of qubits (calculate adjacency as in the above step).
9. In case one or more logical qubits were not allocated a slot in the steps above, allocate slots for the qubits randomly from available remaining slots.
10. Select the quantity of T-factories in each T-factory patch based on the number of T-state requests of qubit patches that are scheduled to be routed to the port of each T-factory patch.
   a. Select the number of T-factories in each T-factory patch to be proportionate (as much as possible) to the respective number of T-state requests.

In other cases, the allocation scheme may be described in any other way.

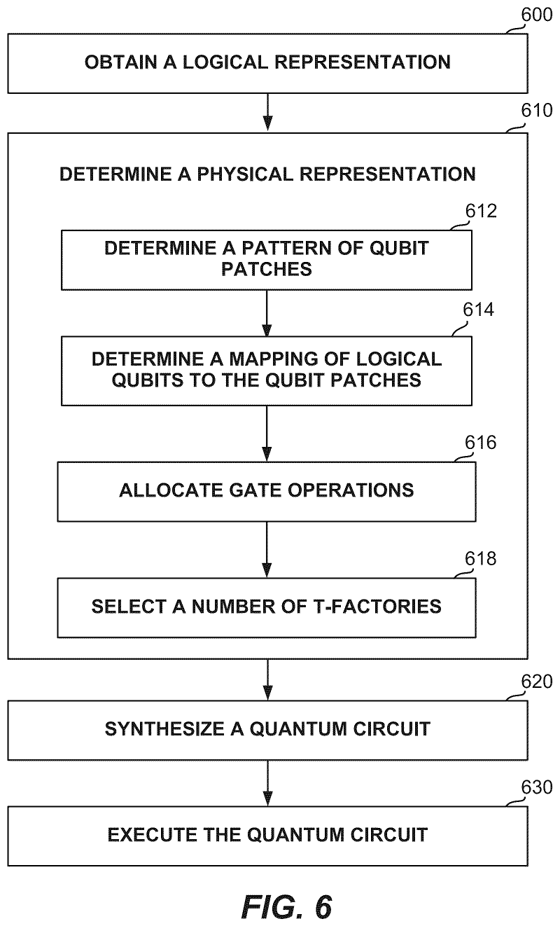

Referring now to FIG. 6, showing an exemplary flowchart diagram of a method, in accordance with some exemplary embodiments of the disclosed subject matter.

On Step 600, a logical representation of a quantum circuit may be obtained, generated, programmed, or the like. In some exemplary embodiments, the logical representation may comprise a plurality of logical qubits that are manipulated by a plurality of logical gate operations. For example, the plurality of gate operations may be defined to be applied on subsets of the plurality of logical qubits. In some exemplary embodiments, the logical qubits may comprise one or more output qubits, through which the logical representation of the quantum circuit may be configured to provide an output.

In some cases, the logical representation of the quantum circuit may comprise a Directed Acyclic Graph (DAG), or any other graph or representations. In some exemplary embodiments, in case of a DAG, the nodes of the DAG may represent the plurality of gate operations, and the edges between the nodes may represent precedence constraints between the plurality of gate operations. In some exemplary embodiments, precedence constraints of the logical representation may be represented in any other way.

On Step 610, a physical representation of the quantum circuit on a quantum computer may be determined, obtained, generated, or the like. In some exemplary embodiments, the physical representation may be generated based on the logical representation, e.g., implementing the logical representation. In some exemplary embodiments, determining the physical representation may be performed according to Sub-Steps 612-618.

In some exemplary embodiments, the quantum circuit may be scheduled to be executed by a quantum execution platform, such as a quantum computer, a quantum cloud, or the like. In some exemplary embodiments, the quantum execution platform may have one or more hardware constraints, e.g., constraints on available qubits, gates, cycles, or the like. In some exemplary embodiments, the physical representation may be generated based on the logical representation, based on precedence constraints of the logical representation, based on hardware constraints of the quantum execution platform, or the like.

In some exemplary embodiments, the physical representation may utilize a surface code technique for representing the plurality of logical qubits. In some exemplary embodiments, the quantum computer may comprise a set of physical qubits positioned on a lattice, plane, connectivity graph, surface or the like, which may be embedded in at least two dimensions. For example, the quantum execution platform may comprise a plurality of physical qubits represented as a lattice of two dimensions, three dimensions, or the like. In some exemplary embodiments, the lattice may comprise a mapping of physical connectivity links between each pair of physical qubits of the lattice (e.g., a connectivity map). In some exemplary embodiments, each two physical qubits may be either connected or not connected, e.g., physically via wires, and this may be indicated via the connectivity map. In some exemplary embodiments, errors of physical qubits may be iteratively corrected every error correction cycle of the surface code technique.

In some exemplary embodiments, generating the physical representation may involve allocating at least a portion of the physical qubits of the quantum execution platform to quantum components of the physical representation. For example, the quantum components may comprise qubit patches, auxiliary patches, T-factory patches, or the like, and the allocation may comprise a division of at least a portion of the lattice into the various types of patches. In some exemplary embodiments, the logical qubits may be represented by the qubit patches, and the logical gate operations may be represented by the auxiliary patches, e.g., as part of the surface code technique. In some exemplary embodiments, the error correction cycles of the surface code technique may enable to iteratively correct errors of the logical qubits, represented as qubit patches of physical qubits.

In some exemplary embodiments, each allocated patch may be selected to comprise connected physical qubits from the lattice, such that no patch comprises an isolated physical qubit that is not physically connected to any other physical qubit in the same patch. In some exemplary embodiments, the patches may be disjoint, e.g., may be selected such that no physical qubit belongs to more than one patch. For example, each physical qubit of the lattice may belong to at most a single patch of any type.

On Sub-Step 612, determining the physical representation may comprise determining a pattern of laying out qubit patches over the lattice. In some exemplary embodiments, the qubit patches may comprise disjoint qubit patches (with disjoint physical qubits) that are configured to represent the plurality of logical qubits of the logical representation (e.g., input qubits, auxiliary qubits, output qubits, or the like). In some exemplary embodiments, properties of the qubit patches may be set according to a pre-defined partitioning framework, e.g., the partitioning framework of FIG. 3. For example, the qubit patches may comprise 2-qubit patches, e.g., each qubit patch set to comprise two slots for representing two respective logical qubits. In other cases, the qubit patches may comprise any other type of patches with any other number of slots.

In some exemplary embodiments, the pattern of the qubit patches may comprise an arrangement of the qubit patches in a first number of rows and a second number of columns. In some exemplary embodiments, the determination of the pattern may involve selecting the number of rows and columns of the patches. In some exemplary embodiments, the number of rows and columns of the qubit patches may be selected in a manner that minimizes an area occupied by the set of qubit patches and by the one or more auxiliary patches surrounding the set of qubit patches, as set by the pre-defined partitioning framework. In some exemplary embodiments, in case a few selections of the number of rows and columns result with a same minimized area, the area that has a shape that is closest to a square may be selected therefrom.

In some exemplary embodiments, the selection of the pattern may affect the auxiliary patches, e.g., since the pre-defined partitioning framework that is used may define the ratio between qubit and auxiliary patches. In some exemplary embodiments, the auxiliary patches may be configured to represent an auxiliary region for performing quantum operations such as the plurality of gate operations between at least a subset of the qubit patches. For example, auxiliary patches may be defined to comprise areas of the lattice surrounding the rows and the columns, according to a specified ratio, in order to provide full connectivity between qubit patches and allow application of gate paths therebetween, e.g., similar to FIG. 3. In other cases, a partitioning framework may be used that does not provide full connectivity between qubit patches.

In some exemplary embodiments, since the configuration of the qubit patches influences the auxiliary patches, the impact on the auxiliary patches may be taken into account when determining the number of rows and columns of the qubit patches. For example, the total areas covered by the set of qubit patches and by the one or more auxiliary patches surrounding the set of qubit patches, resulting from different pattern selections, may be calculated, and the pattern that results with the smallest area may be selected.

On Sub-Step 614, determining the physical representation may comprise determining a mapping between the logical qubits of the quantum circuit and the qubit patches that were laid out on Sub-Step 612. For example, after selecting a number of rows and columns of qubit patches, the mapping may be determined. In some exemplary embodiments, for each logical qubit, a slot of a patch from the plurality of qubit patches may be selected for representing the logical qubit. In some exemplary embodiments, the mapping may be determined based on first and second factors.

In some exemplary embodiments, the first factor may comprise, for each pair of logical qubits, a number of simultaneous T-states requests that are initiated by the pair of logical qubits. In some exemplary embodiments, pairs of logical qubits may be scored based on the first factor. In some exemplary embodiments, the pairs of logical qubits may be ordered according to their scores, e.g., from the highest number of simultaneous T-states requests and downwards. In some exemplary embodiments, a set of top scoring pairs of logical qubits may have a greater number of the simultaneous T-states requests compared to lower scoring pairs of logical qubits. In some exemplary embodiments, the set of top scoring pairs may be selected for the allocation process, e.g., based on a score threshold, a threshold number of top scoring pairs (e.g., the top seven pairs), or the like. In some exemplary embodiments, for each selected top scoring pair, an allocation into first and second slots of different qubit patches may be selected. In some exemplary embodiments, the first slot may be selected to comprise an available slot that is most adjacent to a first port of a first T-factory patch, while the second slot may be selected to comprise an available slot that is most adjacent to a second, different, port of a second T-factory patch. In case of more than two available slots with a same adjacency to different ports, the selection may be performed randomly therefrom.

In some exemplary embodiments, the second factor comprises, for each pair of logical qubits, a number of quantum operations that are scheduled to manipulate the pair simultaneously, without using a T-state. In some exemplary embodiments, the remaining logical qubits that were not scheduled according to the first factor may be scored according to the second factor, thereby obtaining second scores. In other cases, also scheduled qubits may be scored according to the second factor.

In some exemplary embodiments, the logical qubit pairs may be ordered according to their second scores, from high scores atop and downwards. In some exemplary embodiments, a set of logical qubits may be selected to be allocated, e.g., from the remaining logical qubits, according to their second scores. For example, the set may comprise all the remaining logical qubit pairs, top scoring logical qubits that were not yet scheduled, top scoring logical qubits according to one or more thresholds, or the like. In some exemplary embodiments, for each pair from the set (starting with the higher scoring pairs), the pair of logical qubits may be processed to determine whether the logical qubits were not yet allocated to slots, and in case a logical qubit was not allocated, it may be allocated to respective available slots of qubit patches such that the slots of the pair that are most adjacent to each other compared to other available slots.

In some exemplary embodiments, an adjacency between two elements, such as slots of qubit patches, may be calculated based on a number of physical qubits of the lattice that are comprised in a shortest path between the two elements. In some exemplary embodiments, the shortest path may be part of one or more auxiliary patches.

On Sub-Step 616, gate operations and measurements between qubit patches, ports, or the like, may be allocated to a set of physical cycles, e.g., after performing the mapping. In some exemplary embodiments, the auxiliary region may be used for implementing qubit routes between the subset of the plurality of qubit patches, measurements, or the like. In some exemplary embodiments, the plurality of gate operations may be implemented via the auxiliary patches, such as by transferring a quantum state from a slot of a first qubit patch representing a first logical qubit, via the auxiliary region, to a slot of a second qubit patch representing a second logical qubit.

In some exemplary embodiments, gate operations may be allocated to a same cycle in case their qubit routes do not collide, and a simultaneous execution of the gate operation does not contradict precedence constraints. In some exemplary embodiments, paths in the auxiliary patches may be allocated for the logical gate operations over the lattice according to collision constraints. In some exemplary embodiments, the collision constraints may define that the paths cannot collide with one another, within a same physical and/or logical cycle. For example, an auxiliary path that is allocated for a gate operation between first and second logical qubits may comprise a path that physically connects first and second qubit patches representing the first and second logical qubits.

In some cases, the allocation of slots may be dynamically adjusted based on the determined allocation of gate operations. For example, first and second logical qubits may be scored based on a number of collisions between their paths, and the allocation of slots for the first and second logical qubits may be adjusted to reduce the number of collisions. In other cases, the allocation of slots may not be adjusted.

On Sub-Step 618, based on the mapping between logical qubits and slots, and based on the allocated gate operations, a number of T-factories to be included in each T-factory patch may be determined. In some exemplary embodiments, the T-factory patches may represent T-factories for producing magic states, T-states, or the like. In some exemplary embodiments, the number of T-factories to be included in each T-factory patch may be determined by calculating a number of requests for T-states that are scheduled to reach each port of each T-factory patch. For example, the number of requests may be calculating by determining for each allocated gate operations a number of T-states it uses (zero or more), and a port from which the T-states can be obtained. For example, the number of scheduled requests for T-states may be determined according to the mapping of Sub-Step 614, and may result from the mapping.

In some exemplary embodiments, for each T-factory patch that has a respective port, an allocation of T-factories may be performed based on the load of T-state requests. For example, a number of T-factories that is proportional to the number of requests for T-states that are scheduled to reach a port of the T-factory patch may be selected. In some cases, the proportionality may be rounded, as the division may not be precise.

On Step 620, the quantum circuit may be synthesized according to the determined physical representation, thereby obtaining a synthesized quantum circuit. For example, the synthesized quantum circuit may comprise a quantum circuit that is executable over the quantum execution platform.

On Step 630, the synthesized quantum circuit may be simulated, executed, or the like, e.g., on the quantum execution platform. For example, the synthesized quantum circuit may be executed on a quantum computer.

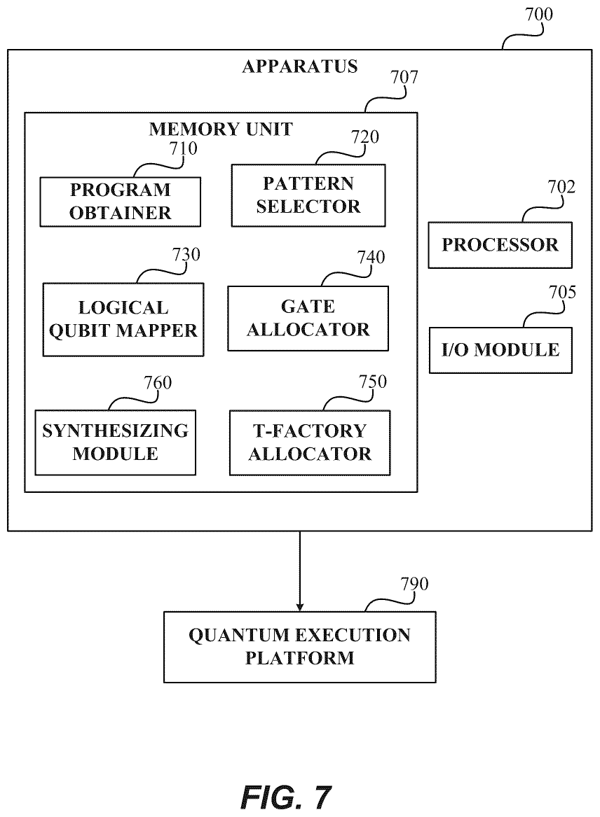

Referring now to FIG. 7 showing a block diagram of an apparatus, in accordance with some exemplary embodiments of the disclosed subject matter.

In some exemplary embodiments, Apparatus 700 may comprise one or more Processor(s) 702. Processor 702 may be a Central Processing Unit (CPU), a microprocessor, an electronic circuit, an Integrated Circuit (IC) or the like. Processor 702 may be utilized to perform computations required by Apparatus 700 or any of its subcomponents. It is noted that Processor 702 may be a traditional classical processor, and not necessarily a quantum processor.

In some exemplary embodiments of the disclosed subject matter, Apparatus 700 may comprise an Input/Output (I/O) module 705. I/O Module 705 may be utilized to provide an output to and receive input from a user, an apparatus, or the like, such as, for example to obtain a user-defined quantum program, to obtain a user-defined objective function, showing circuit illustrations, communicating with quantum hardware, or the like.

In some exemplary embodiments, Apparatus 700 may comprise Memory 707. Memory 707 may be a hard disk drive, a Flash disk, a Random Access Memory (RAM), a memory chip, or the like. In some exemplary embodiments, Memory 707 may retain program code operative to cause Processor 702 to perform acts associated with any of the subcomponents of Apparatus 700. Memory 707 may comprise one or more components as detailed below, implemented as executables, libraries, static libraries, functions, or any other executable components.

In some exemplary embodiments, Memory 707 may comprise a Program Obtainer 710. Program Obtainer 710 may obtain a quantum program, e.g., a logical representation of a quantum circuit, from a user, a server, a computing device, or the like. In some cases, Program Obtainer 710 may obtain the quantum program via I/O Module 705.

In some exemplary embodiments, Memory 707 may comprise a Pattern Selector 720, which may be configured to select a number of rows and columns of qubit patches. In some exemplary embodiments, the layout of the auxiliary patches may be determined to match the selected pattern.

In some exemplary embodiments, Memory 707 may comprise a Logical Qubit Mapper 730, which may be configured to map logical qubits to slots of qubit patches determined by Patch Selector 720.

In some exemplary embodiments, Memory 707 may comprise a Gate Allocator 740, which may be configured to schedule the logical gates to one or more cycles. Each gate or measurement may be mapped to respective paths between qubit patches, ports, or the like, within the auxiliary patches.

In some exemplary embodiments, Memory 707 may comprise a T-Factory Allocator 750. In some exemplary embodiments, T-Factory Allocator 750 may select a number of T-factories, from available T-factories, for each T-factory patch. In some exemplary embodiments, the selection may be performed based on the gate allocations and mapping of logical qubits to qubit patches.

In some exemplary embodiments, Synthesizing Module 760 may be configured to synthesize a quantum circuit according to the selected settings and configurations. In some cases, Synthesizing Module 760 may be configured to generate an executable quantum circuit that is executable over Quantum Execution Platform 790, or any other execution platform. The synthesized quantum circuit obtained from Synthesizing Module 760 may enable to execute the quantum circuit on Quantum Execution Platform 790, or to simulate execution of the quantum circuit using an emulator, a simulator, or the like, on a classic computer.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a logical representation of a quantum circuit, wherein the logical representation comprises a plurality of logical qubits, wherein the logical representation defines a plurality of logical gate operations on subsets of the plurality of logical qubits;
determining a physical representation of the quantum circuit based on the logical representation, said determining comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising:
determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches;
determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and
determining, based on the mapping, a number of T-factories to be included in each T-factory patch of the set of T-factory patches; and
synthesizing the quantum circuit according to the physical representation, thereby obtaining a synthesized quantum circuit.

2. The method of claim 1, wherein said determining the pattern comprises selecting the first and second numbers so that an area occupied by the set of qubit patches and by the one or more auxiliary patches surrounding the set of qubit patches, is minimized.

3. The method of claim 2, wherein said determining the pattern comprises selecting the first and second numbers such that a shape of the area over the lattice is closest to a square shape.

4. The method of claim 1, wherein said determining the mapping comprises:
scoring pairs of logical qubits based on the first factor;
ordering the pairs of logical qubits according to their scores, wherein top scoring pairs of logical qubits have a greater number of the simultaneous T-states requests compared to lower scoring pairs of logical qubits;
selecting the top scoring pairs; and
allocating, for a pair of logical qubits from the top scoring pairs, first and second slots in first and second different qubit patches, the first slot is selected to comprise an available slot that is most adjacent to a first port of a first T-factory patch, the second slot is selected to comprise an available slot that is most adjacent to a second port of a second T-factory patch, the first and second ports are different.

5. The method of claim 4, wherein said selecting the top scoring pairs is performed according to a score threshold or according to a defined number of pairs.

6. The method of claim 4 further comprising:
scoring a set of remaining logical qubits based on the second factor, thereby obtaining second scores, wherein the set of remaining logical qubits comprise logical qubits not elected by said selecting the top scoring pairs;
ordering the set of remaining logical qubits according to their second scores, from high scores and downwards;
selecting a set of logical qubits pairs from the set of remaining logical qubits, based on said ordering; and
allocating, for a pair of logical qubits from the set of logical qubits pairs, third and fourth slots of qubit patches, the third and fourth slots are selected to comprise a pair of available slots that are most adjacent to each other compared to other available slots.

7. The method of claim 4, wherein an adjacency between two elements is calculated based on a number of physical qubits of the lattice that are comprised in a shortest path between the two elements, the shortest path is part of the one or more auxiliary patches.

8. The method of claim 1, wherein said determining the number of T-factories to be included in each T-factory patch comprises:
calculating a number of requests for T-states that are scheduled to reach each port of each T-factory patch as results from said mapping; and
selecting, for a T-factory patch, a number of T-factories that is most proportional to the number of requests for T-states that are scheduled to reach a port of the T-factory patch.

9. The method of claim 1 further comprising allocating for the plurality of logical gate operations, respective paths in the one or more auxiliary patches over a set of physical cycles, wherein said allocating the paths is performed according to collision constraints defining that the paths cannot collide within a same physical cycle.

10. The method of claim 9, wherein an auxiliary path that is allocated for a gate operation between first and second logical qubits comprises a path that physically connects first and second qubit patches from the set of qubit patches, the first and second qubit patches representing the first and second logical qubits according to said mapping.

11. The method of claim 1 further comprising:
scoring first and second logical qubits based on a number of collisions between their paths; and
based on said scoring, adjusting an allocation of slots for the first and second logical qubits.

12. The method of claim 1, wherein the physical representation utilizes a surface code technique for representing the plurality of logical qubits by the set of qubit patches and for representing the plurality of logical gate operations by the one or more auxiliary patches, whereby errors of the plurality of logical qubits are iteratively corrected every error correction cycle of the surface code technique.

13. The method of claim 1, wherein the logical representation of the quantum circuit comprises a Directed Acyclic Graph (DAG), wherein nodes of the DAG represent the plurality of logical gate operations, wherein edges between the nodes represent precedence constraints between the plurality of logical gate operations.

14. The method of claim 1, wherein the lattice comprises a mapping of physical connectivity links between each two physical qubits of the set of physical qubits, wherein the each two physical qubits of the set of physical qubits are either connected or not connected.

15. The method of claim 1 further comprising executing the synthesized quantum circuit on a quantum computer.

16. An apparatus comprising a processor and coupled memory, said processor being adapted to:
obtain a logical representation of a quantum circuit, wherein the logical representation comprises a plurality of logical qubits, wherein the logical representation defines a plurality of logical gate operations on subsets of the plurality of logical qubits;
determine a physical representation of the quantum circuit based on the logical representation, said determine comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising:
determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches;
determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and
determining, based on the mapping, a number of T-factories to be included in each T-factory patch of the set of T-factory patches; and
synthesize the quantum circuit according to the physical representation, thereby obtaining a synthesized quantum circuit.

17. The apparatus of claim 16, wherein the physical representation utilizes a surface code technique for representing the plurality of logical qubits by the set of qubit patches and for representing the plurality of logical gate operations by the one or more auxiliary patches, whereby errors of the plurality of logical qubits are iteratively corrected every error correction cycle of the surface code technique.

18. The apparatus of claim 16, wherein the logical representation of the quantum circuit comprises a Directed Acyclic Graph (DAG), wherein nodes of the DAG represent the plurality of logical gate operations, wherein edges between the nodes represent precedence constraints between the plurality of logical gate operations.

19. The apparatus of claim 16, wherein the processor is adapted to execute the synthesized quantum circuit on a quantum computer.

20. A computer program product comprising a non-transitory computer-readable medium retaining program instructions, which program instructions, when read by a processor, cause the processor to:
obtain a logical representation of a quantum circuit, wherein the logical representation comprises a plurality of logical qubits, wherein the logical representation defines a plurality of logical gate operations on subsets of the plurality of logical qubits;
determine a physical representation of the quantum circuit based on the logical representation, said determine comprising allocating at least a portion of a set of physical qubits of a quantum computer to quantum components of the physical representation, the set of physical qubits is positioned on a lattice embedded in at least two dimensions, the quantum components comprising at least a set of T-factory patches, said allocating comprising:
determining a pattern of a set of disjoint qubit patches, the set of qubit patches representing the plurality of logical qubits, wherein a qubit patch from the set of qubit patches comprises two slots for representing two respective logical qubits from the plurality of logical qubits, wherein the pattern comprises an arrangement of the set of qubit patches in a first number of rows and a second number of columns, said determining the pattern comprising selecting the first and second numbers, wherein said determining the pattern comprises determining one or more auxiliary patches, the one or more auxiliary patches comprise areas of the lattice surrounding the rows and the columns, wherein the one or more auxiliary patches are configured to provide full connectivity between qubit patches of the set of qubit patches;
determining a mapping of the plurality of logical qubits to the set of qubit patches based on first and second factors, wherein the first factor comprises, for each pair of logical qubits of the plurality of logical qubits, a number of simultaneous T-states requests that are initiated by the pair of logical qubits, wherein the second factor comprises, for each pair of logical qubits, a number of quantum operations that are scheduled to manipulate the pair of logical qubits without obtaining a T-state; and
determining, based on the mapping, a number of T-factories to be included in each T-factory patch of the set of T-factory patches; and
synthesize the quantum circuit according to the physical representation, thereby obtaining a synthesized quantum circuit.
